(19) United States
(12) Patent Application Publication
(10) Pub. No.: US 2024/0338022 A1
(43) Pub. Date: Oct. 10, 2024

(54) SYSTEM AND METHOD FOR DOCKING AN AUTONOMOUS VEHICLE

(71) Applicant: DEKA Products Limited Partnership, Manchester, NH (US)

(72) Inventors: Michael J. Slate, Merrimack, NH (US); Thomas F. Soldau, Bedford, NH (US); Emily A. Carrigg, Weare, NH (US); Paul L. Adams, Dover, NH (US); Thaddeus J. Hughes, Manchester, NH (US); Justin M. Whitney, Goffstown, NH (US); Perry F. Craver, Gilford, NH (US); Garrett M. Pierson, Manchester, NH (US); Abhishek Ravi, Manchester, NH (US); Benjamin V. Hersh, Raymond, NH (US); David J. Meehan, Londonderry, NH (US); Christopher C. Langenfeld, Nashua, NH (US)

(21) Appl. No.: 18/296,630

(22) Filed: Apr. 6, 2023

(51) Int. Cl. G05D 1/02

(52) U.S. Cl. CPC G05D 1/0225

(57) ABSTRACT

A docking system for an AV may include a connector coupled to an electronics housing of a docking station and configured to operably engage an AV to couple the AV to the electronics housing, a processor coupled to the connector and configured to enable fast-charging of the AV through the connector, a processor coupled to the connector and configured to transfer data to and receive data from the AV through the connector, and a processor of the AV configured to automatically align the AV with the connector. The docking system may further include a weather enclosure to house an AV while the AV is docked.

### CROSS REFERENCE TO RELATED APPLICATIONS

None

### BACKGROUND

This disclosure relates generally to an autonomous vehicle (“AV”). More specifically, this disclosure pertains to docking and charging stations for AVs and their respective interactions.

It would be desirable for AVs such as, for example, delivery and security robots, to be conveniently and efficiently charged in order to have power to operate. It would also be desirable for AVs to exchange data including, for example, receiving maps, software updates, package locations, and/or delivery destinations. It would be further desirable to enable delivery robots to be protected from inclement weather conditions.

The above-described background is intended to provide a contextual overview of some current issues, and is not intended to be exhaustive.

### BRIEF DESCRIPTION OF THE DRAWINGS

Non-limiting and non-exhaustive aspects of the subject disclosure are described with reference to the following figures, wherein like reference numerals refer to like parts throughout the various views unless otherwise specified.

FIG. 1 is a perspective view of an AV engaged with a docking station in a docked position in accordance with various aspects of the subject disclosure.

FIG. 2 is a perspective view of an AV preparing to engage with a docking station in accordance with various aspects of the subject disclosure.

FIG. 3 is a perspective view of multiple docking stations arranged in series to engage with one or more AVs in accordance with various aspects of the subject disclosure.

FIG. 4 is a perspective view of a docking station in accordance with various aspects of the subject disclosure.

FIG. 5 is a front view of a docking station in accordance with various aspects of the subject disclosure.

FIG. 6 is a side view of a docking station in accordance with various aspects of the subject disclosure.

FIG. 7 is an exploded view of a docking station in accordance with various aspects of the subject disclosure.

FIG. 8 is a cross-sectional view of a docking station in accordance with various aspects of the subject disclosure.

FIG. 9 is an exploded view of a docking station in accordance with various aspects of the subject disclosure.

FIG. 10 is a block diagram of a base station that accommodates a plurality of docking stations in accordance with various aspects of the subject disclosure.

FIG. 11 is a block diagram of a base station that incorporates wireless data transfer with a plurality of AVs in accordance with various aspects of the subject disclosure.

FIG. 12 is a block diagram of a base station that incorporates wired data transfer with, and charging of, a plurality of docking stations in accordance with various aspects of the subject disclosure.

FIG. 13 is a block diagram of a base station that incorporates charging of a plurality of AVs through one or more charging units in accordance with various aspects of the subject disclosure.

FIG. 14 is a block diagram of a base station that incorporates charging of, and data transfer with, a plurality of AVs through one or more charging units in accordance with various aspects of the subject disclosure.

FIG. 15A is a perspective view of a docking station in accordance with various aspects of the subject disclosure.

FIG. 15B is a side view of a docking station in accordance with various aspects of the subject disclosure.

FIG. 15C is a plan view of a docking station in accordance with various aspects of the subject disclosure.

FIG. 15D is a front view of a docking station in accordance with various aspects of the subject disclosure.

FIG. 16A is a perspective view of an AV engaged with a docking station in a docked position in accordance with various aspects of the subject disclosure.

FIG. 16B is a side view of an AV engaged with a docking station in a docked position in accordance with various aspects of the subject disclosure.

FIG. 16C is a plan view of an AV engaged with a docking station in a docked position in accordance with various aspects of the subject disclosure.

FIG. 16D is a front view of an AV engaged with a docking station in a docked position in accordance with various aspects of the subject disclosure.

FIG. 17 is a perspective view of a docking station in accordance with various aspects of the subject disclosure.

FIG. 18 is a perspective view of an engagement mechanism in accordance with various aspects of the subject disclosure.

FIG. 19 is an exploded perspective view of an engagement mechanism in accordance with various aspects of the subject disclosure.

FIG. 20 is a perspective view of an engagement mechanism in accordance with various aspects of the subject disclosure.

FIG. 20A is an exploded partial perspective view of an engagement mechanism in accordance with various aspects of the subject disclosure.

FIG. 20B is an exploded view of an engagement mechanism in accordance with various aspects of the subject disclosure.

FIG. 21A is a plan view of a docking station and a block diagram of an AV in accordance with various aspects of the subject disclosure.

FIG. 21B is a process diagram of a process for docking an AV in a docking station in accordance with various aspects of the subject disclosure.

FIG. 21C is a process diagram of a process for docking an AV in a docking station in accordance with various aspects of the subject disclosure.

FIG. 22 is a flow diagram of an autonomous system for docking an AV to a docking station in accordance with various aspects of the subject disclosure.

FIG. 23 is a state diagram that illustrates example states for docking an AV in accordance with various aspects of the subject disclosure.

FIG. 24 is a block diagram of a cascade controller in accordance with various aspects of the subject disclosure.

FIG. 25 is a diagram of an example path alignment process in accordance with various aspects of the subject disclosure.

FIGS. 26-29 are plan views of an AV engaging a docking station in accordance with various aspects of the subject disclosure.

FIG. 30 is a partial front, right side elevational view of an AV in accordance with various aspects of the subject disclosure.

FIGS. 31A and 31B are partial front views of an AV and a connector thereof in accordance with various aspects of the subject disclosure.

FIG. 31C is a partial front, right side elevational view of an AV engaging with a docking station in accordance with various aspects of the subject disclosure.

FIGS. 32A and 32B are partial top, right side elevational views of an AV spool engaging and having engaged docking station detents in accordance with various aspects of the subject disclosure.

FIG. 33 is a cross-sectional detail view of a cylinder of an engagement mechanism in accordance with various aspects of the subject disclosure.

### DETAILED DESCRIPTION OF THE PREFERRED EMBODIMENTS

The examples shown in drawings are presented only to demonstrate certain examples of the disclosure. And, the drawings are merely illustrative and are non-limiting. In the drawings, for illustrative purposes, the size of some of the elements may be exaggerated and not drawn to a particular scale. Additionally, elements shown within the drawings that have the same numbers may be identical elements or may be similar elements, depending on the context.

Where the term “comprising” is used in the present description and claims, it does not exclude other elements or steps. Where an indefinite or definite article is used when referring to a singular noun, e.g., “a”, “an”, or “the”, this includes a plural of that noun unless something otherwise is specifically stated. Hence, the term “comprising” should not be interpreted as being restricted to the items listed thereafter; it does not exclude other elements or steps, and so the scope of the expression “a device comprising items A and B” should not be limited to devices consisting only of components A and B. Furthermore, to the extent that the terms “includes”, “has”, “possesses”, and the like are used in the present description and claims, such terms are intended to be inclusive in a manner similar to the term “comprising,” as “comprising” is interpreted when employed as a transitional word in a claim.

Furthermore, the terms “first”, “second”, “third”, and the like, whether used in the description or in the claims, are provided to distinguish between similar elements and not necessarily to describe a sequential or chronological order. It is to be understood that the terms so used are interchangeable under appropriate circumstances (unless clearly disclosed otherwise) and that the aspects of the disclosure described herein are capable of operation in other sequences and/or arrangements than are described or illustrated herein.

In the following description, numerous specific details are set forth to provide a thorough understanding of various aspects and arrangements. It will be recognized, however, that the techniques described herein can be practiced without one or more of the specific details, or with other methods, components, materials, etc. In other instances, well known structures, materials, or operations may not be shown or described in detail to avoid obscuring certain aspects.

Reference throughout this specification to “an aspect,” “an arrangement,” “a configuration,” or “an example” indicates that a particular feature, structure, or characteristic is described. Thus, appearances of phrases such as “in one aspect,” “in one arrangement,” “in a configuration,” “in some examples,” or the like in various places throughout this specification do not necessarily each refer to the same aspect, feature, configuration, example, or arrangement. Furthermore, the particular features, structures, and/or characteristics described may be combined in any suitable manner.

To the extent used in the present disclosure and claims, the terms “component,” “system,” “platform,” “layer,” “selector,” “interface,” and the like are intended to refer to a computer-related entity or an entity related to an operational apparatus with one or more specific functionalities, wherein the entity may be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server itself can be a component. One or more components may reside within a process and/or thread of execution and a component may be localized on one computer and/or distributed between two or more computers. In addition, components may execute from various computer-readable media, device-readable storage devices, or machine-readable media having various data structures stored thereon. The components may communicate via local and/or remote processes such as in accordance with a signal having one or more data packets (e.g., data from one component interacting with another component in a local system, a distributed system, and/or across a network such as the Internet with other systems via the signal). As another example, a component can be an apparatus with specific functionality provided by mechanical parts operated by electric or electronic circuitry, which may be operated by a software or firmware application executed by a processor, wherein the processor can be internal or external to the apparatus and executes at least a part of the software or firmware application. As yet another example, a component can be an apparatus that provides specific functionality through electronic components without mechanical parts; the electronic components can include a processor therein to execute software or firmware that confers at least in part the functionality of the electronic components.

To the extent used in the subject specification, terms such as “store,” “storage,” “data store,” data storage,” “database,” and the like refer to memory components, entities embodied in a memory, or components comprising a memory. It will be appreciated that the memory components described herein can be either volatile memory or nonvolatile memory, or can include both volatile and nonvolatile memory.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject disclosure and claims should generally be construed to mean “one or more” unless specified otherwise or clear from context to be directed to a singular form.

The words “exemplary” and/or “demonstrative,” to the extent used herein, mean serving as an example, instance, or illustration. For the avoidance of doubt, the subject matter disclosed herein is not limited by disclosed examples. In addition, any aspect or design described herein as “exemplary” and/or “demonstrative” is not necessarily to be construed as preferred or advantageous over other aspects or designs, nor is it meant to preclude equivalent exemplary structures and techniques. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, application data, implicit data, explicit data, etc. Inference can be employed to identify a specific context or action or can generate a probability distribution over states of interest based on a consideration of data and events, for example.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture,” to the extent used herein, is intended to encompass a computer program accessible from any computer-readable device, machine-readable device, computer-readable carrier, computer-readable media, or machine-readable media. For example, computer-readable media can include, but are not limited to, a magnetic storage device, e.g., hard disk; floppy disk; magnetic strip(s); an optical disk (e.g., compact disk (CD), digital video disc (DVD), Blu-ray Disc (BD)); a smart card; a flash memory device (e.g., card, stick, key drive); a virtual device that emulates a storage device; and/or any combination of the above computer-readable media.

Generally, program modules include routines, programs, components, data structures, etc., that perform particular tasks or implement particular abstract data types. The illustrated aspects of the subject disclosure may be practiced in distributed computing environments where certain tasks are performed by remote processing devices that are linked through a communications network. In a distributed computing environment, program modules can be located in both local and remote memory storage devices.

Computing devices can include at least computer-readable storage media, machine-readable storage media, and/or communications media. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media that can be used to store desired information. In this regard, the terms “tangible” or “non-transitory” herein as applied to storage, memory, or computer-readable media, are to be understood to exclude only propagating transitory signals per se as modifiers, and do not exclude any standard storage, memory, or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

A system bus, as may be used herein, can be any of several types of bus structure that can further interconnect to a memory bus (with or without a memory controller), a peripheral bus, and a local bus using any of a variety of commercially available bus architectures. A database, as may be used herein, can include basic input/output system (BIOS) that can be stored in a non-volatile memory such as ROM, EPROM, or EEPROM, with BIOS containing the basic routines that help to transfer information between elements within a computer, such as during startup. RAM can also include a high-speed RAM such as static RAM for caching data.

As used herein, a computer can operate in a networked environment using logical connections via wired and/or wireless communications to one or more remote computers. The remote computer(s) can be a workstation, server, router, personal computer, portable computer, microprocessor-based entertainment appliance, peer device, or other common network node. Logical connections depicted herein may include wired/wireless connectivity to a local area network (LAN) and/or larger networks, e.g., a wide area network (WAN). Such LAN and WAN networking environments are commonplace in offices and companies, and facilitate enterprise-wide computer networks, such as intranets, any of which can connect to a global communications network, e.g., the Internet.

When used in a LAN networking environment, a computer can be connected to the LAN through a wired and/or wireless communication network interface or adapter. The adapter can facilitate wired or wireless communication to the LAN, which can also include a wireless access point (AP) disposed thereon for communicating with the adapter in a wireless mode.

When used in a WAN networking environment, a computer can include a modem or can be connected to a communications server on the WAN via other means for establishing communications over the WAN, such as by way of the Internet. The modem, which can be internal or external, and a wired or wireless device, can be connected to a system bus via an input device interface. In a networked environment, program modules depicted herein relative to a computer or portions thereof can be stored in a remote memory/storage device.

When used in either a LAN or WAN networking environment, a computer can access cloud storage systems or other network-based storage systems in addition to, or in place of, external storage devices. Generally, a connection between a computer and a cloud storage system can be established over a LAN or a WAN, e.g., via an adapter or a modem, respectively. Upon connecting a computer to an associated cloud storage system, an external storage interface can, with the aid of the adapter and/or modem, manage storage provided by the cloud storage system as it would other types of external storage. For instance, the external storage interface can be configured to provide access to cloud storage sources as if those sources were physically connected to the computer.

As employed in the subject specification, the term “processor” can refer to substantially any computing processing unit or device comprising, but not limited to comprising, single-core processors; single-core processors with software multithread execution capability; multi-core processors; multi-core processors with software multithread execution capability; multi-core processors with hardware multithread technology; vector processors; pipeline processors; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a state machine, a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. For example, a processor may be implemented as one or more processors together, tightly coupled, loosely coupled, or remotely located from each other. Multiple processing chips or multiple devices may share the performance of one or more functions described herein, and similarly, storage may be effected across a plurality of devices. A processor may be implemented to reside in a cloud-based network such as, e.g., the Internet.

Various arrangements are described herein. For simplicity of explanation, the methods or algorithms are depicted and described as a series of steps or actions. It is to be understood and appreciated that the various arrangements are not limited by the actions illustrated and/or by the order of actions. For example, actions can occur in various orders and/or concurrently, and with other actions not presented or described herein. Furthermore, not all illustrated actions may be required to implement the methods. In addition, the methods could alternatively be represented as a series of interrelated states via a state diagram or events. Additionally, the methods described hereafter are capable of being stored on an article of manufacture, as defined herein, to facilitate transporting and transferring such methodologies to computers.

In the ensuing description, an autonomous base may be a location at which docking stations are stored. Depending on the location of the base, a weather enclosure may be incorporated. The term “base station” refers to a system that may accommodate multiple docking stations and may incorporate a weather enclosure. The term “docking station” refers to a physical docking point for storage, charging, and/or data uploading for an AV. The term “weather enclosure” refers to a housing that facilitates weather-proofing of an AV from the environment. The weather enclosure could be included as part of the base or it could be a separate unit.

An example AV may interface with a docking station. In one example, the AV may be a level 4 robot able to operate without human intervention. In an example, the robot may be configured to deliver packages directly to a doorstep. In an example, the delivery robot may be intended to pick up a single package or multiple packages from a shipping service or a customer of the shipping service, and autonomously deliver the package or packages to a specified destination. A robot may be configured to be stationed at a base station, at which power source maintenance may take place. In an example, a base station may contain one or more docking stations. In an example, a docking station may provide a physical connection to an AV for charging and communication. In an example, a base station may communicate with an AV and a remote operator simultaneously. For example, a base station may communicate its location to a remote operator. As another example, a base station may communicate a state of charging to an AV while the AV is connected to a docking station of the base station. The AV may be configured to trigger charging when the AV is driven into the docking station and coupled thereto by a remote operator.

Upon receipt of delivery directions, or a navigation package that contains the pickup and drop off locations for a delivery package, a valid route containing, for example, but not limited to, drivable surfaces, curbs, intersections, traffic signals, and appropriate QR codes for the delivery, a robot may leave a base station and proceed to a pickup point or location. In an example, the robot may drive on a sidewalk and/or on a road. At a pickup location, a robot may drive inside a building if appropriate access is available. In one example, a package may include electronically identifiable indicia, for example, but not limited to, a QR code, a bar code, and/or an RFI tag. In an example, a robot may initiate a package delivery pickup process and then travel on a road and/or on a sidewalk to a drop off location and initiate a drop off process. When a robot confirms that a delivery package has been delivered, the robot may return to a base station or continue to another delivery. When all deliveries are complete, a robot may return to a base station.

In some examples, a base station may include a docking station, or multiple docking stations. When a robot is docked at a base station, automated administrative tasks may be performed, including power supply maintenance. In an example, if a power supply includes batteries, the batteries can be charged and/or swapped out. In an example, a docking station may be configured to detect and confirm that a robot is correctly coupled with a charging port before any power is supplied. In an example, a docking station may be configured to charge a robot at up to a 1C charge rate (25 Amps). In an example, a docking station may be configured to operate on a power supply delivering any input voltage between 100 Volts AC and 240 Volts AC, single phase 50 Hz-60 Hz. In other examples, a docking station may be configured to enable wireless charging of a robot. In an example, a docking station may include communications capability. For example, a docking station may include a communications system that accommodates a wired and/or a wireless communications connection capable of supporting high speed communications. In an example, a docking station may include fiducials to allow for automatic camera calibration for stereo cameras of a robot.

In an example, the base station may include a weather enclosure that provides shelter and an environment that accommodates requirements appropriate for power supply maintenance. For example, if a power supply is a battery, the weather enclosure may perform thermal adjustment for fast charging of the battery. For example, a weather enclosure may maintain the temperature of the enclosed area of the weather enclosure between a range of 0° C. and 45° C. In another example, a weather enclosure may maintain the temperature of the enclosed area of the weather enclosure between a range of 5° C. and 35° C. In an example, a weather enclosure may allow visibility to a rear screen of a robot and automatic entry into the weather enclosure for the robot. A weather enclosure may be protected against limited ingress of dust, harmful deposits, water splashed from any or all directions, and/or strong jets of water, as examples.

In an example, a docking station may receive an AV in a forward-facing direction and may include features configured to enable the AV to autonomously drive into the docking station such as, for example, but not limited to, mechanical guides and/or camera targets. In an example, a docking station may be configured to accept manual positioning of an AV and release the AV whether the AV is powered on or off, and/or whether the docking station is powered or not.

In an example, a docking station may be configured to support a data rate of at least 10 Mbps per AV, preferably with at least 110 Volt/15 Amp power available. In an example, a docking station may be configured to enable an AV to identify a base station (that has a unique identifier, for example, physical or virtual) when the AV is fully docked. For example, a docking station may itself enable base station identification, or a remote facility may provide base station identity to an AV. An advantage of a vehicle identifying a docking station is so that it understands its initial position or starting point, for example after starting up or initiating for a first time and not having a point of reference.

In an example, a docking station may be configured to manage charging failure modes such as a loss of communication.

In an example, a docking station may be configured to host an Ethernet connection preferably capable of supporting gigabit Ethernet communication and enable data for upload/download from/to an AV thereby.

In some examples, recharging and data transfer with respect to a fleet of AVs may include a base station hosting a plurality of docking stations. A base station, preferably, is located anywhere that includes network access and power. Docking station capacity of a base station may be limited by the electrical and data capacity of the location. Base station could be provided with its own power generation and data transfer capabilities.

### DETAILED DESCRIPTION OF THE PREFERRED EMBODIMENTS

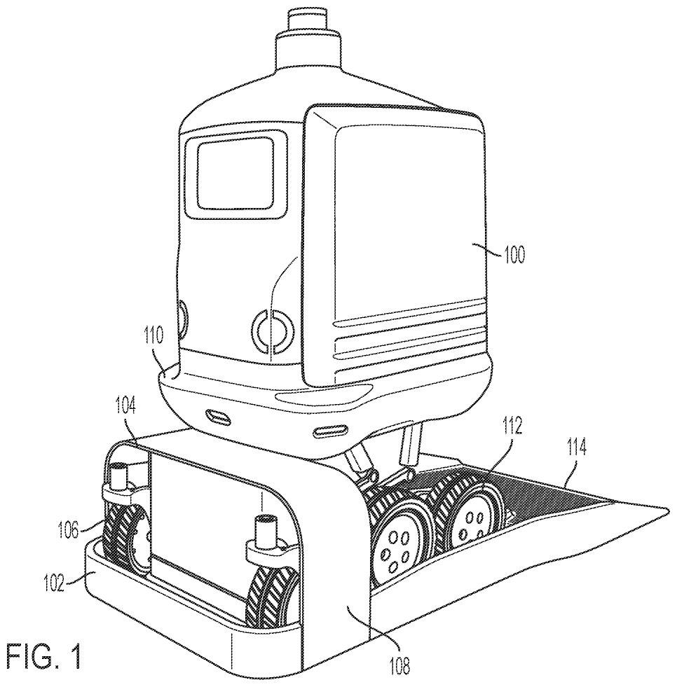

In the perspective view of FIG. 1, an AV 100 is depicted engaged with an embodiment of a docking station 102 in a docked position. In a docked position, the AV 100 may securely lock into a power supply 104 and a data transfer processor (not shown) including, e.g., a modem, of the docking station 102. The geometry of the docking station 102 may be designed, in an example, to accommodate the particular features of the AV 100. In an example, a docking station 102 may include wheel wells (not shown) that accommodate caster wheels 106 of the AV 100. A power supply housing 108 may be sized to allow an upper portion 110 of an AV 100 to clear the power supply housing 108. An AV may include multiple wheels 112 in an example. A docking station 102 may include a ramp 114 to accommodate entry by an AV 100.

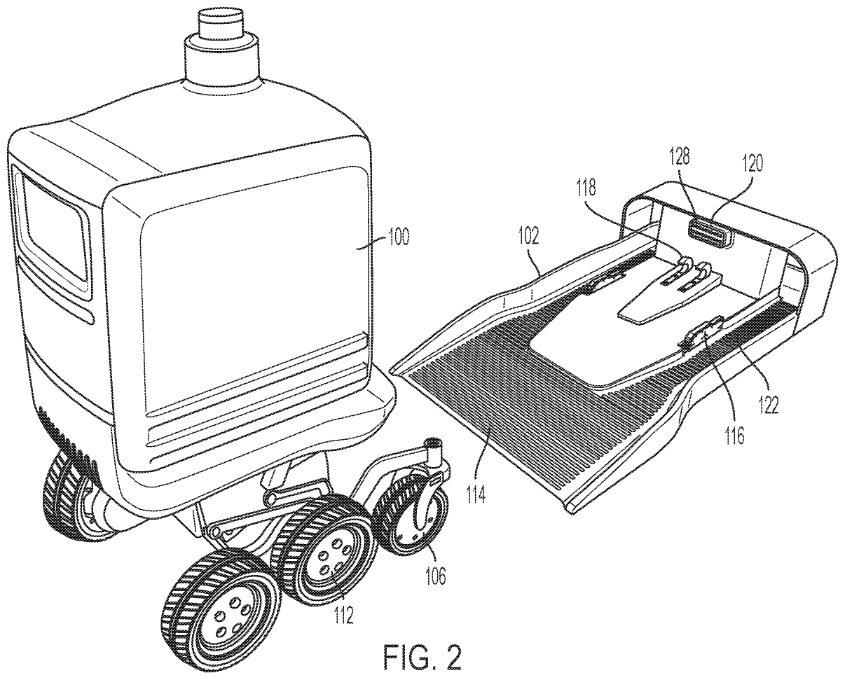

In the perspective view of FIG. 2, an AV 100 is depicted preparing to engage with a docking station 102. The AV 100 has a controller (not shown) that directs the AV 100 up ramp 114 into docking station 102 and detects when the AV 100 has engaged with a charging and/or data transfer port 120. The docking station 102 preferably includes tracks 116 configured to engage and encourage the AV 100 to lock into at least one fastening detent 118 and the charging and/or data transfer port 120. Wheel wells 122 of the docking station 102 may accommodate caster wheels 106 of the AV 100.

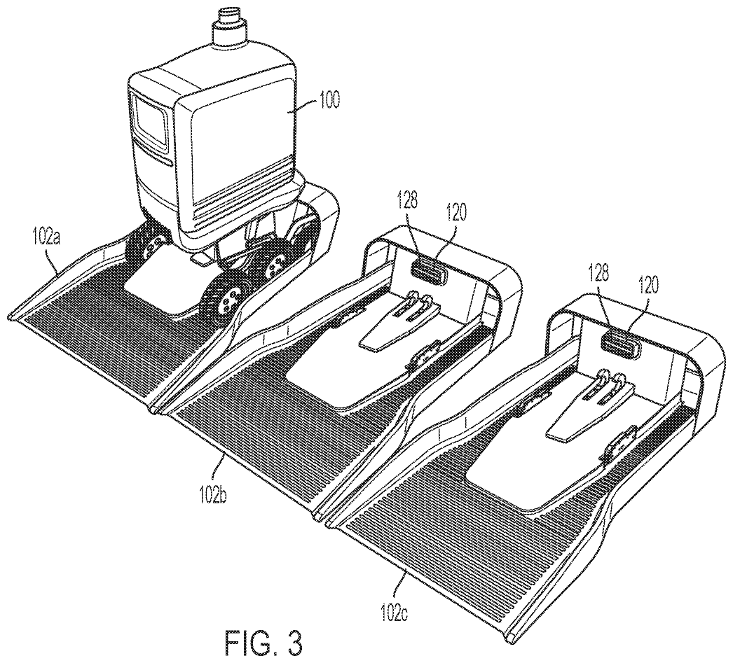

The perspective view of FIG. 3 shows an arrangement of multiple docking stations 102a-c in series configured to engage with one or more AVs 100. The multiple docking stations 102a-c may accommodate multiple AVs 100 in a fleet of AVs.

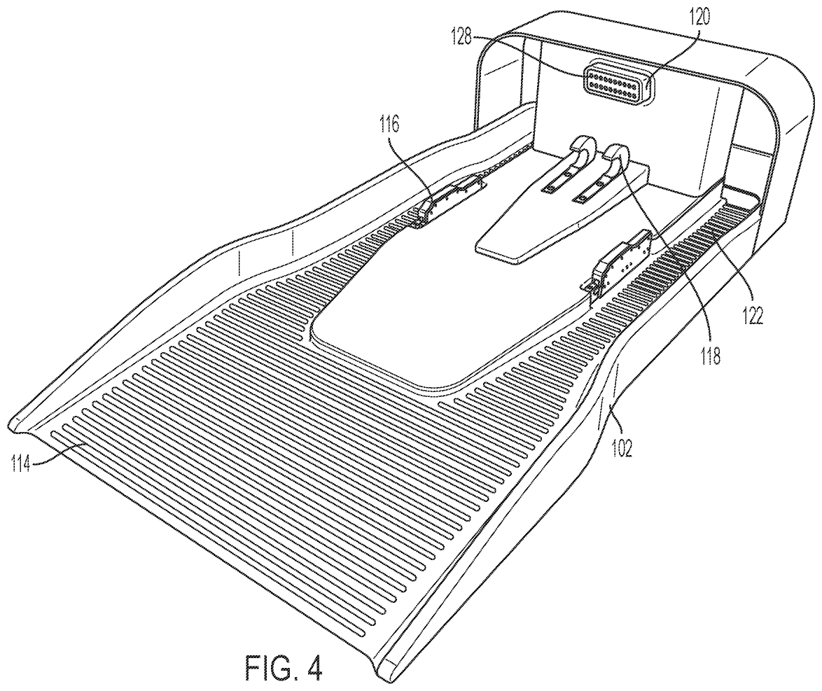

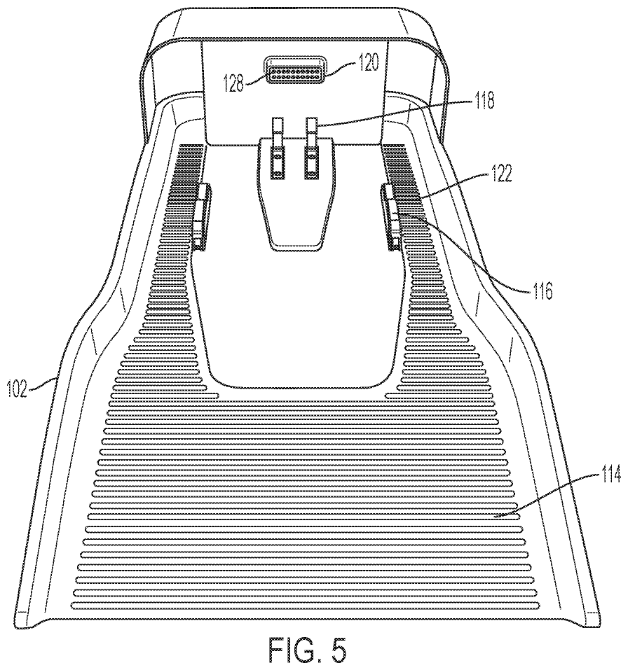

Referring to FIGS. 4 and 5, two fastening detents 118 are shown, but any number of detents 118 may be used, depending upon the weight and dimensions of the AV 100. Detents 118 may be configured and oriented to grasp a bumper and/or undercarriage of an AV (not shown) as the AV (not shown) arrives in the docking station 102. In another example, an AV (not shown) could traverse spring-mounted detents (not shown) that are oriented to grasp a bumper and/or undercarriage of the AV (not shown) after the AV (not shown) has crossed over the spring-mounted detents (not shown).

Referring to FIG. 4, ramp 114 may include tracks 116 configured to engage and move an AV (not shown) toward a charging and/or data transfer port 120 when the spring-mounted detents (not shown) have engaged with an undercarriage (not shown) of the AV (not shown). In another example, a ramp 114 can include tracks 116 configured to engage and urge AV (not shown) toward data transfer port 120, for example, as soon as the weight of the AV (not shown) is registered on the ramp 114. Such tracks 116 may extend the length of the ramp 114. In another example, a ramp 114 may include wheel guides 122, or wheel wells 122, to encourage an AV (not shown) to line up correctly with a charging and/or data transfer port 120. The wheel guides 122 may be contoured according to an expected shape of wheels (not shown) of an AV (not shown).

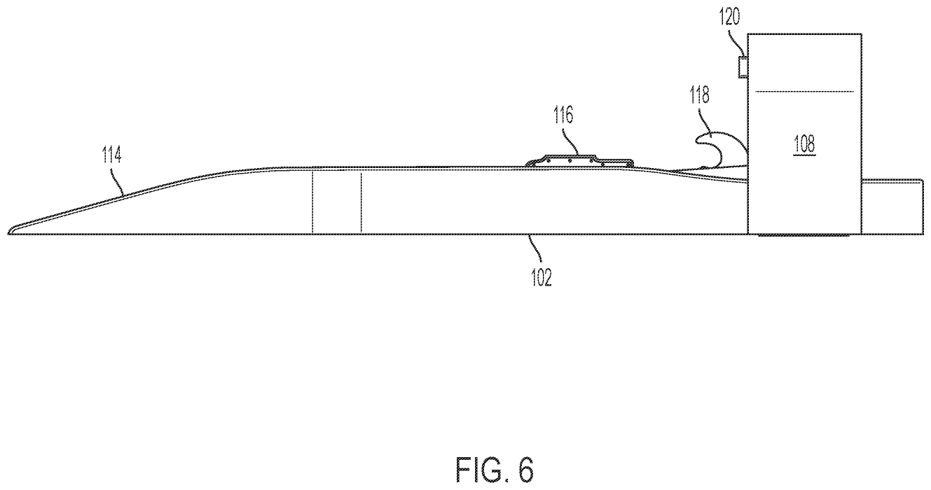

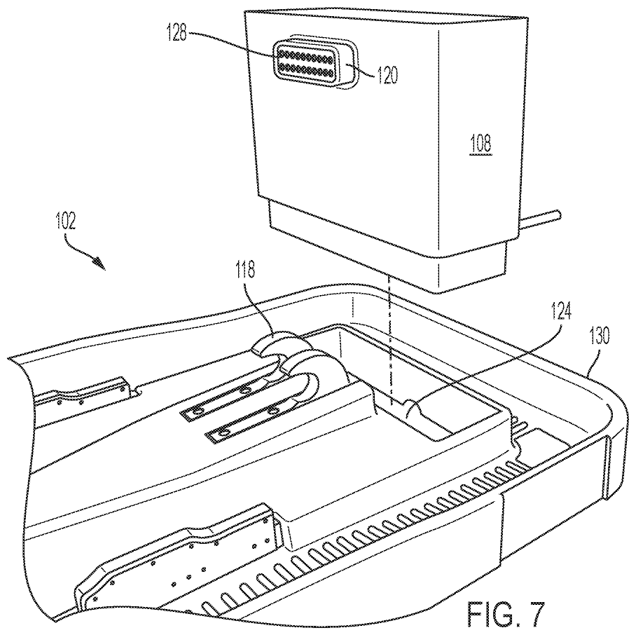

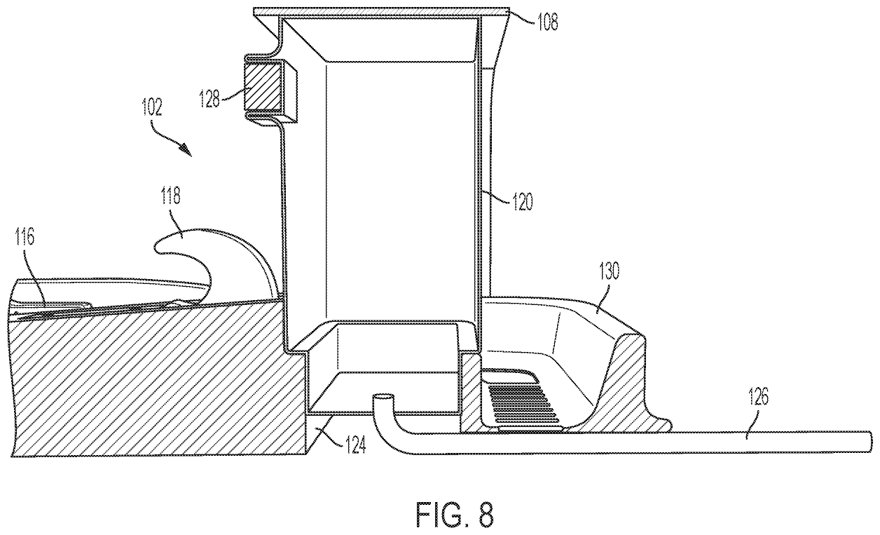

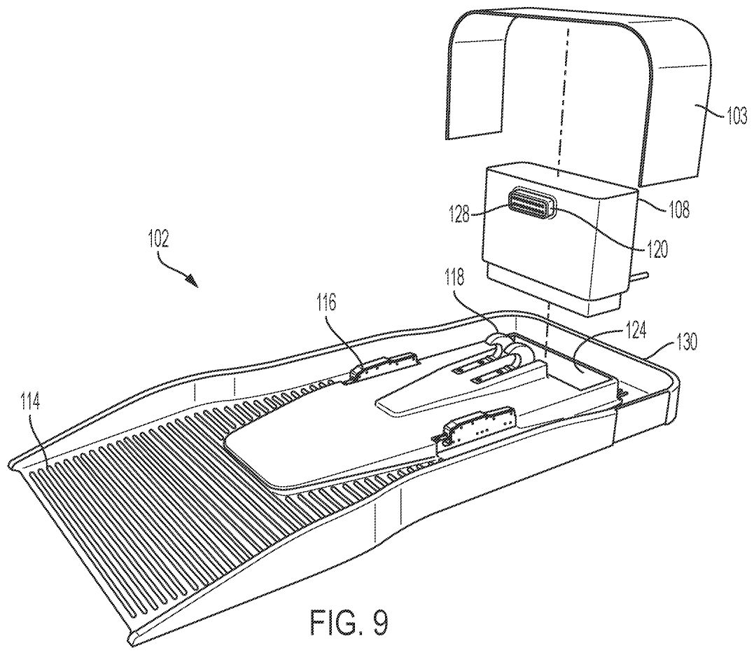

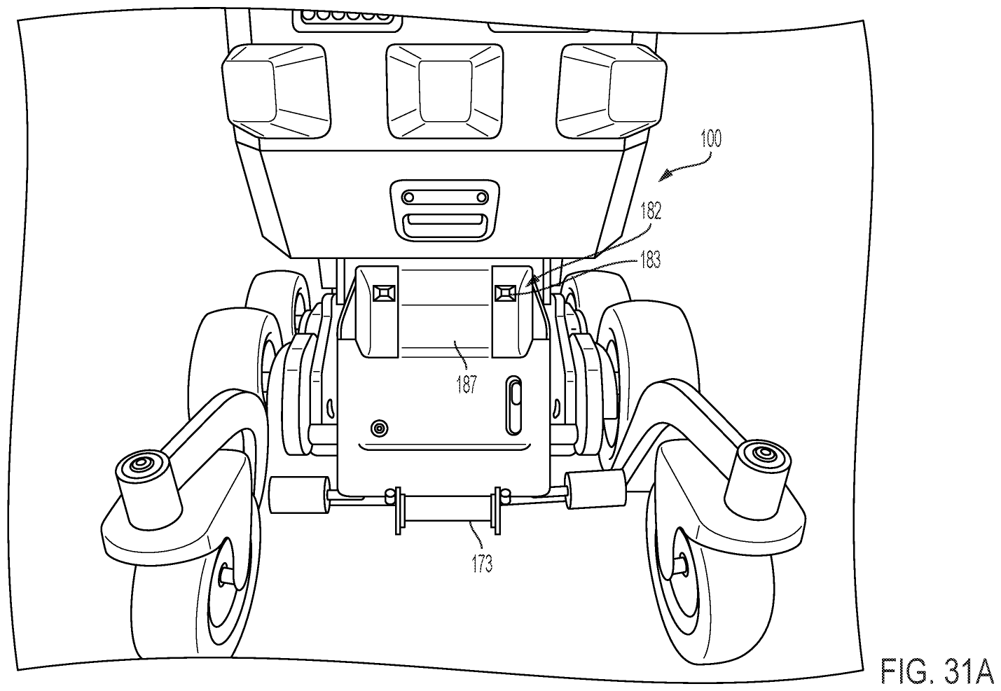

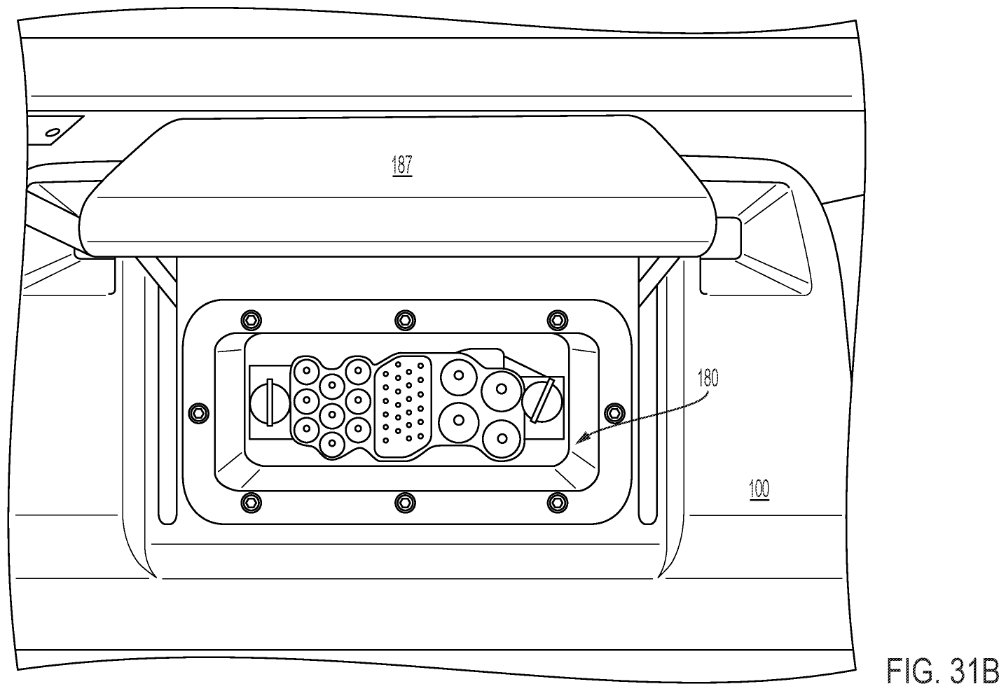

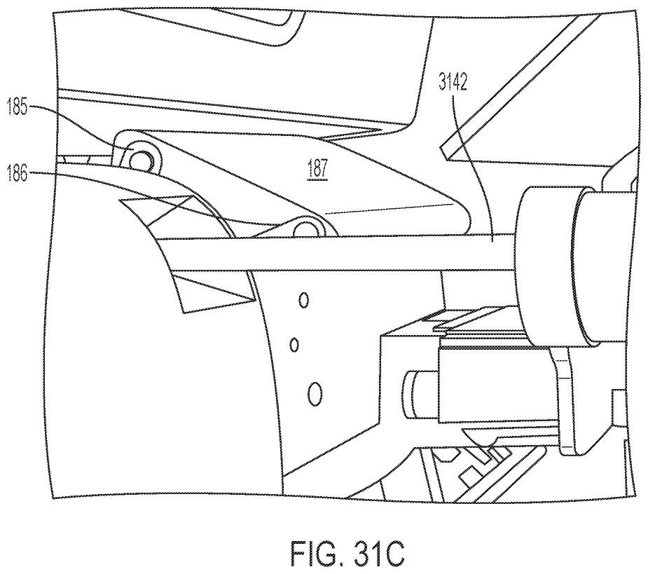

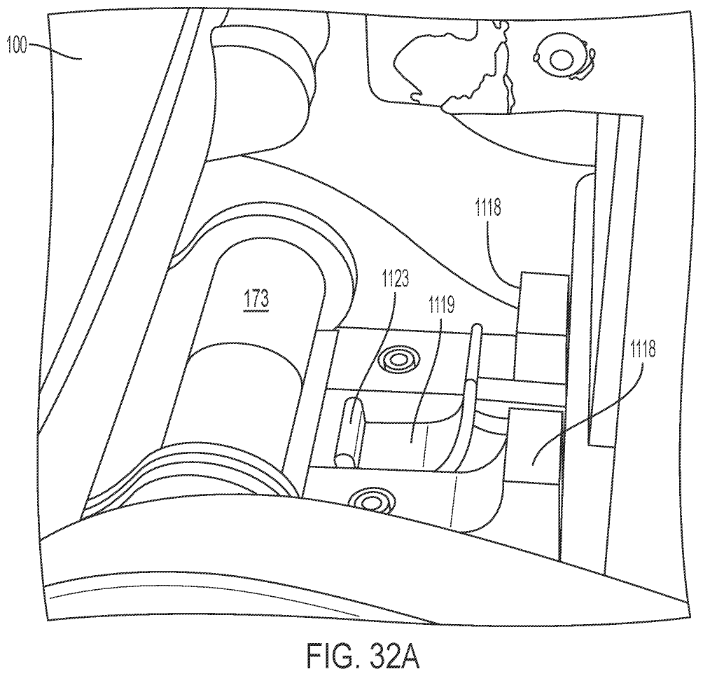

In the side view of FIG. 6, exploded view of FIG. 7, FIG. 8 and exploded view of FIG. 9, a docking station 102 is depicted to illustrate various examples of engagement of the docking station 102 with a charging and/or data transfer port 120. For example, a docking station 102 may include a mounting well 124 configured to receive power supply housing 108 having a charging and/or data transfer port 120. Mounting well 124 may have any depth that can be accommodated by the docking station 102, including being flush with a top surface of the docking station 102, depending upon the geometry of an AV (not shown), among other considerations. Charging and/or data transfer port 120 may be covered by a weather-shielding housing 103 depending upon the needs of the particular installation. Alternatively, docking station 102 may be housed entirely within a weatherproof enclosure. Docking station 102 may include cable tunnels 126 as necessary to orderly route power and data cables (not shown). A charging and/or data transfer port 120 may include a connector 128 to engage a mating connector 180 on an AV 100, as shown in FIG. 31B. Docking station 102 may include outer walls 130 to help secure the wheels (not shown) of an AV (not shown).

Referring again to FIG. 1, when AV 100 is received in docking station 102, and connector (not shown) from AV 100 engages with connector 128 of docking station 102, then battery charging may commence. Engagement of the connectors may but is not required to enable data transfer unless wired transfer is contemplated. Engagement is not required where wireless data transfer is contemplated, but could serve as a triggering event to commence data transfer in addition to battery charging.

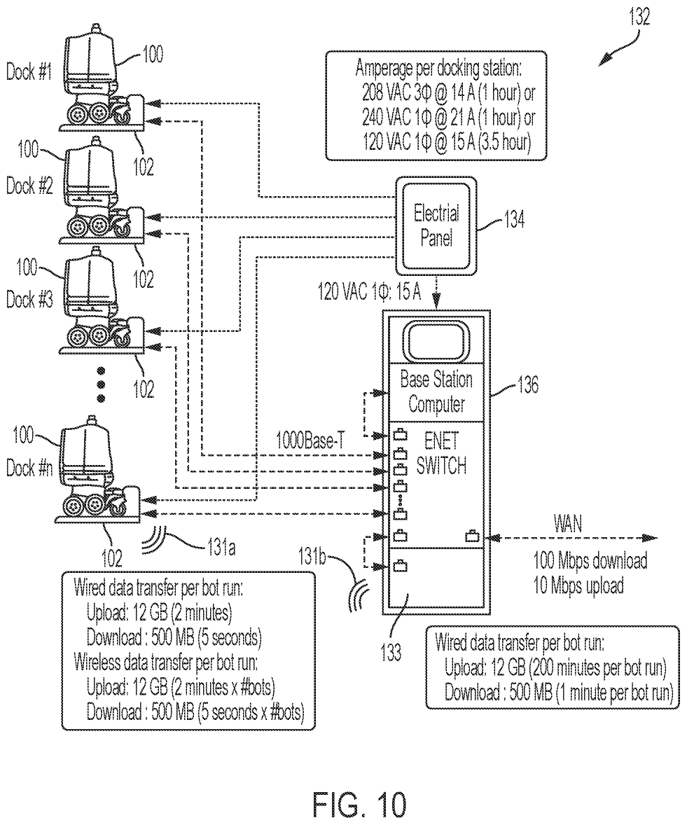

In the block diagram of FIG. 10, a base station 132 is shown that can accommodate a plurality of docking stations 102. Base station 132 may include an electrical power supply panel 134 that is electrically coupled with a data transfer station 136. The electrical panel 134 may, in an example, accommodates pre-charging, slow charging and fast charging, depending upon the available electricity supply. For example, a relatively fast charge of one hour can require 208 Volts AC 3-phase at 14 Amps, or 240 Volts AC single phase at 21 Amps. A relatively slow charge of 3.5 hours can require 120 Volts AC single phase at 15 Amps. This permits opportunistically charging the battery at a variable rate to take advantage of the AV's operational status to prolong the health of the battery. For example, if the AV were not scheduled to run for several hours, it may charge at a slower rate.

The data transfer station 136 may include a processor that can also be powered by the electrical panel 134 supplying, for example, 120 Volts AC single phase at 15 Amps. The data transfer station 136 may be configured to provide, for example, wired and/or wireless data transfer to/from at least one AV 100 and the data transfer station 136, and, in some examples, between the data transfer station 136 and off-station storage (not shown), such as a remote server or database. In some examples, data upload rates of 6 GB/minute from an AV 100 to the data transfer station 136, and 10 MB/second from the data transfer station 136 to off-station storage (not shown) may be supported by the base station 132. In some examples, data download rates of 100 MB/second from the data transfer station 136 to an AV 100, and 100 MB/second from off-station storage (not shown) to the data transfer station 136 may be supported by the base station 132. Data transfer may be enabled by any or all of, for example: gigabit wired or contact-enabled transmission, such as Ethernet, and/or wireless data transfer or communication 131 via a router 133 configured for Wi-Fi, and/or Wide Area Network (WAN) communication.

In the block diagram of FIG. 11, a base station 132 that incorporates wireless data transfer with a plurality of AVs 100 is depicted. In the example shown, the base station 132 may include a charging unit 138 for at least one battery in an AV 100. The charging unit 138 may be electrically coupled to the electrical panel 134. The data transfer station 136 may be communicatively coupled to the charging unit 138. Wireless data transfer between AVs 100 and the data transfer station 136 may be enabled by a router 133. Standards for wireless data transfer router 133 undertakes may include WI-FI, Bluetooth and the like.

In an alternative example, charging of batteries may be enabled by any of various wireless charging methods, such as inductive charging.

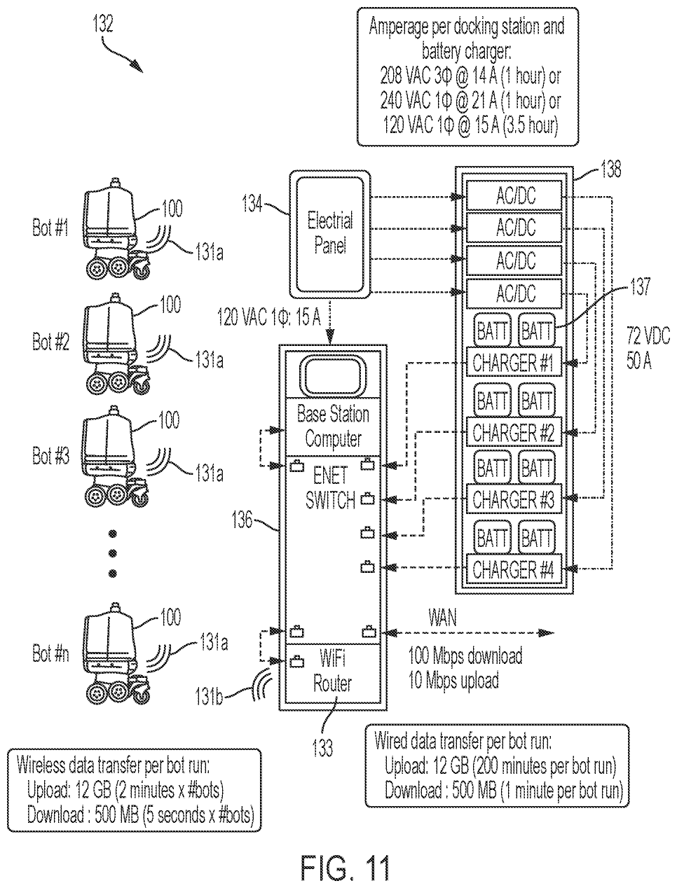

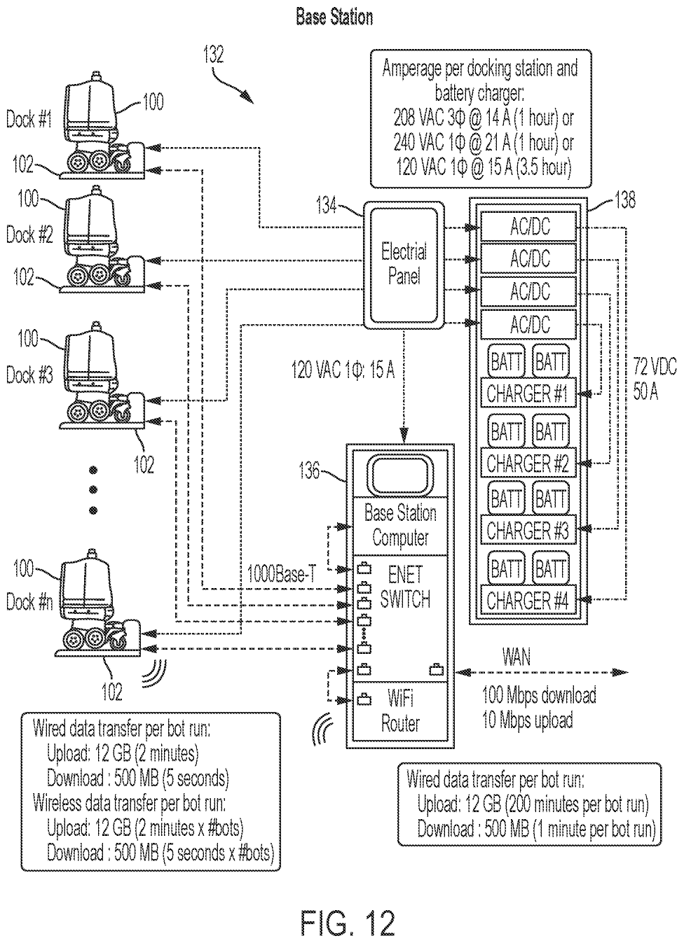

In the block diagram of FIG. 12, a base station 132 that incorporates wired data transfer with, and charging of, a plurality of AVs 100 with a plurality of docking stations 102 is depicted. In the example shown, wired data transfer between docking stations 102 and a data transfer station 136 may be enabled by gigabit Ethernet cabling that couples docking stations 102 to the data transfer station 136. In an alternative example, or in addition, data transfer between docking stations 102 and the data transfer station 136 may be enabled by a router 133. Standards for wireless data transfer may include WI-FI, Bluetooth and the like.

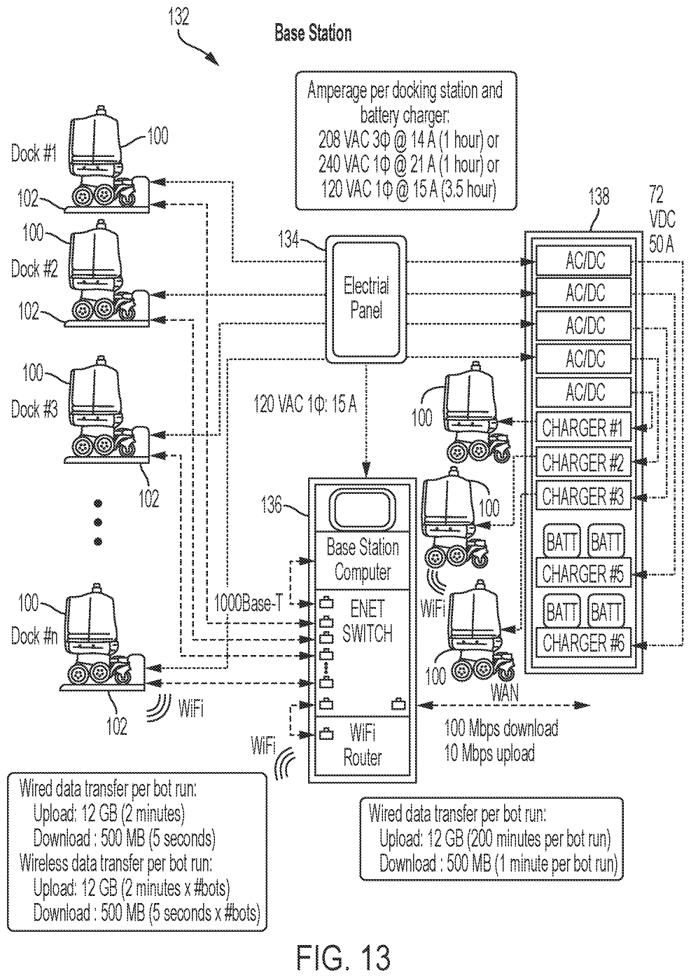

In the block diagram of FIG. 13, a base station 132 that incorporates charging of a plurality of AVs 100 through at least one charging unit 138 is depicted. Charging may be accommodated via grid plugs (not shown). Alternatively or in addition, charging may be enabled wirelessly, such as inductively.

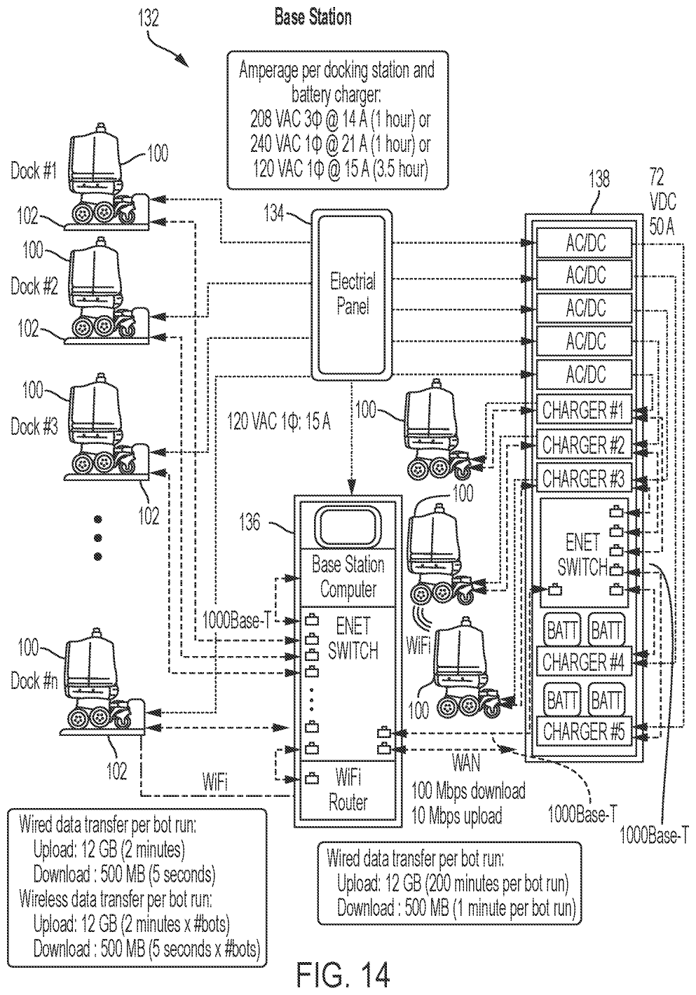

In the block diagram of FIG. 14, a base station that incorporates charging of, and data transfer with, a plurality of AVs 100 through at least one charging unit 138 is depicted. Charging may be accommodated via grid plugs (not shown). Alternatively or in addition, charging may be enabled wirelessly. Data transfer between AVs 100 and a data transfer station 136 may be enabled by, for example, gigabit Ethernet cabling that couples AVs 100 to a charging unit 138 via ground plugs (not shown), and the charging unit 138 may be coupled to the data transfer station 136 via gigabit Ethernet cabling, for example. In the alternative or in addition, data transfer could be done via any of various wireless protocols depending on desired throughput and distance, such as, e.g., Bluetooth, Wi-Fi, or WAN.

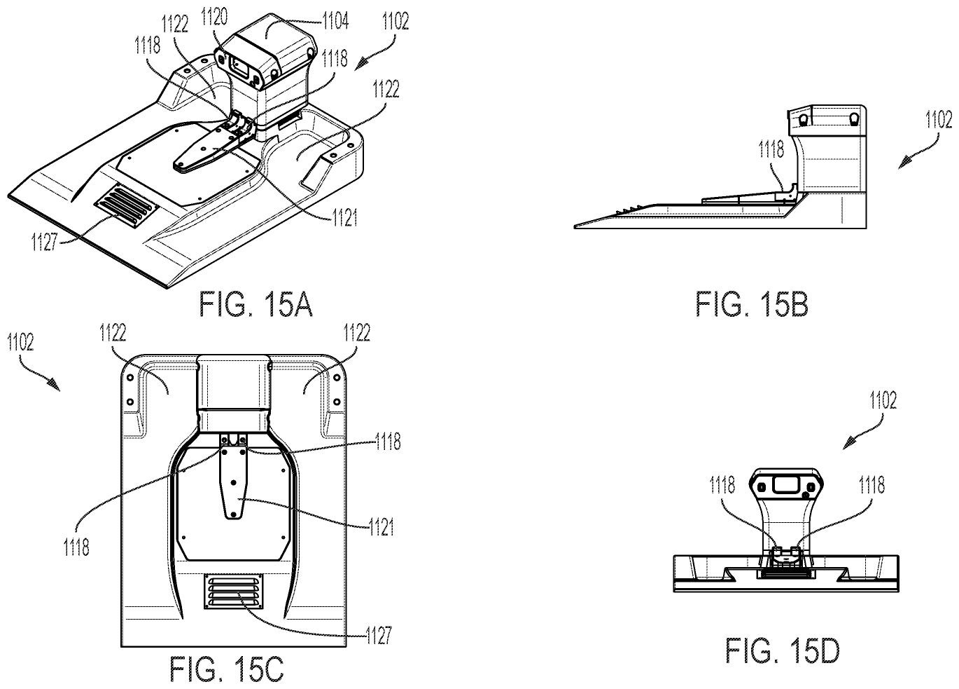

In the perspective view of FIG. 15A, the side view of FIG. 15B, the plan view of FIG. 15C, and the front view of FIG. 15D, another embodiment of a docking station 1102 is depicted at various orientations. In the example shown, docking station 1102 is an alternative configuration to the docking station 102 described with reference to FIGS. 1-9. In the example shown, a docking station 1102 may include wheel wells 1122 and detents 1118, similar to detents 118 described with reference to FIGS. 1-9, at a terminal end of a spool guide 1121.

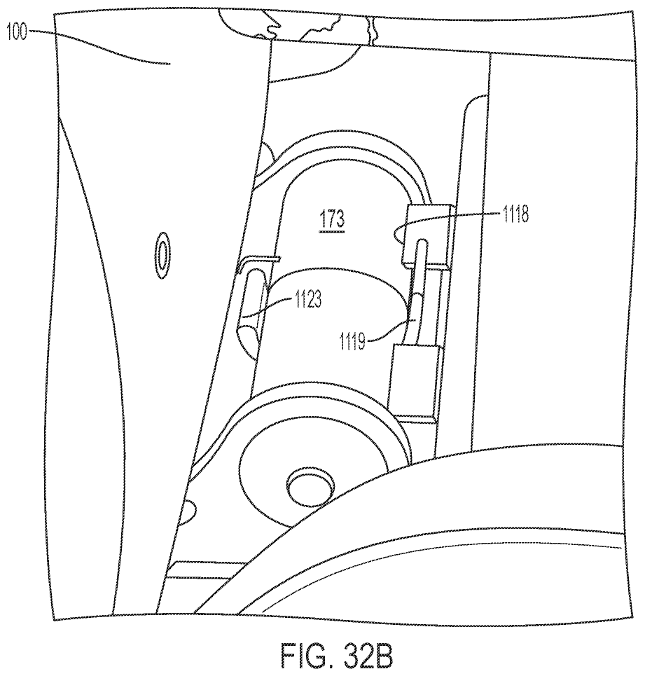

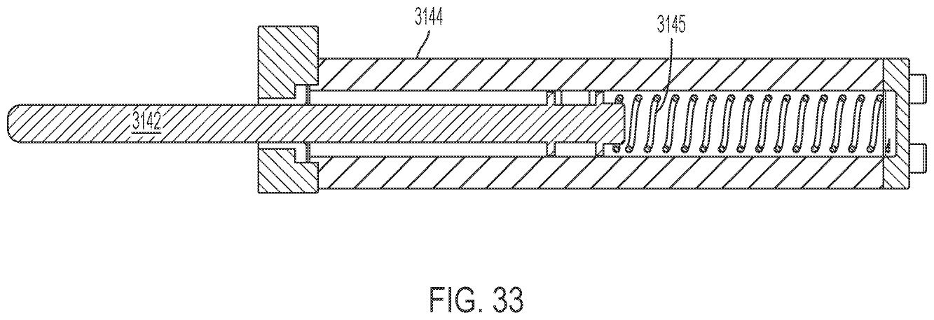

Referring also to FIGS. 32A and 32B, preferably, a u-shaped rocker 1119 is pivotally-mounted generally between detents 1118. After AV 100 enters and travels farther onto docking station 1102, a spool 173 extending from AV 100 eventually contacts spool guide 1121. Spool 173 glides or rolls along spool guide 1121, as shown in FIG. 32A, until it engages rocker 1119, thereafter urging rocker 1119 to pivot so that a lower portion 1123 of rocker 1119 captures spool 173 against detents 1118, as shown in FIG. 32B. Pivoting rocker 1119 initiates the charging routine, including initiating and extending connector 1128 from docking station until it engages with connector 180 of AV. Docking station 1102 maintains rocker 1119 in this locked position to enable charging and/or data transfer.

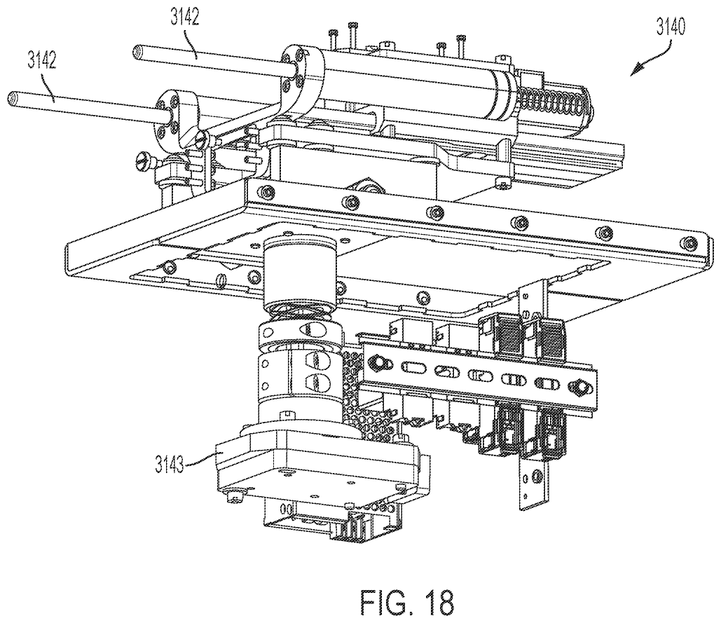

This embodiment differs from that of FIG. 18, which relies on a contact switch 3143 to initiate connector engagement and battery charging rather than pivoting rocker 1119 for same. In other words, the AV's urging rocker 1119 to pivot initiates the connector engagement sequence.

A charging and/or data transfer port 1120 may engage with an AV (not shown) at a docking port on the AV.

In an example, docking station 1102 may include a cooling mechanism (not shown) to prevent a power supply 1104 and the charging and/or data transfer port 1120 from overheating. The cooling mechanism (not shown) may draw air in a vent (not shown) located at the back and toward the top of power supply 1104 and out vent 1127.

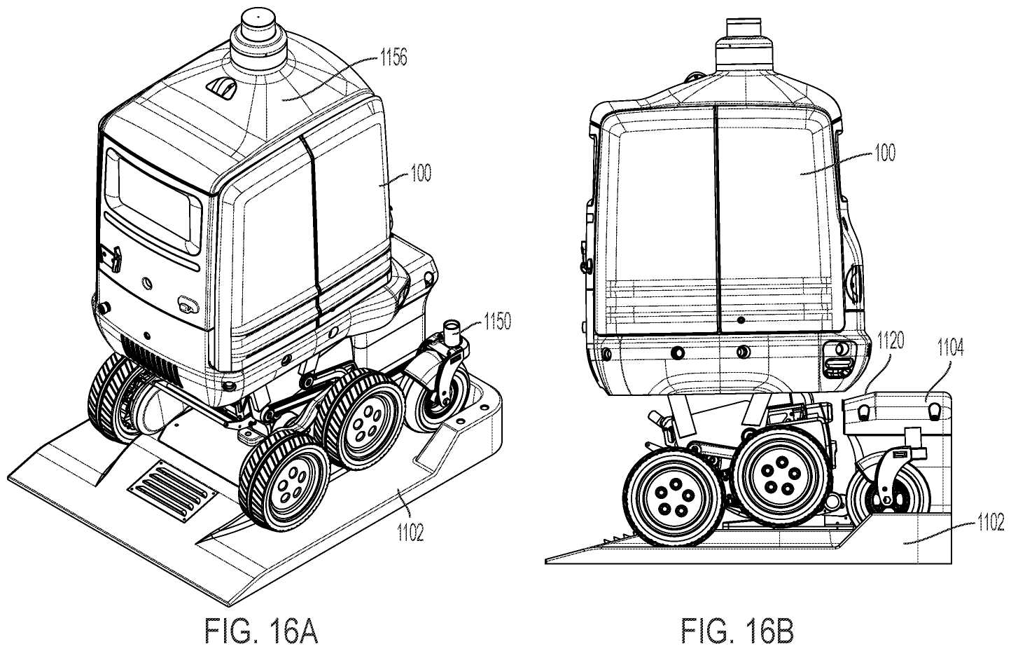

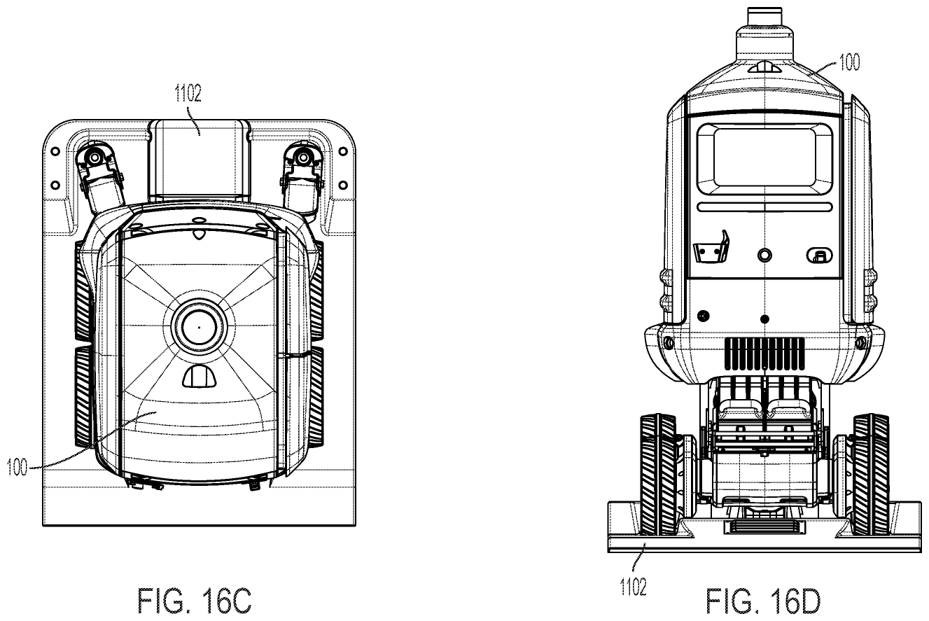

In the perspective view of FIG. 16A, the side view of FIG. 16B, the plan view of FIG. 16C, and the front view of FIG. 16D, an AV 100 engaged with docking station 1102 in a docked position is depicted at various orientations.

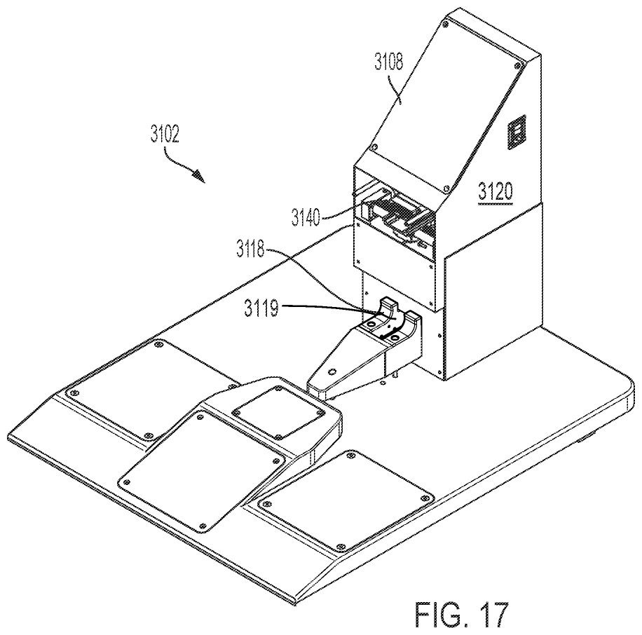

The perspective view of FIG. 17 shows another example of a docking station 3102 that includes a modified power supply housing 3120 that houses an engagement mechanism 3140, and a modified set of detents 3118 for engaging with an AV (not shown) as needed. A rocker 3119 is disposed between detents 3118 for capturing a spool of an AV (not shown) comparable to as described earlier.

Docking station 3102 includes a modified power supply housing 3120 and an engagement mechanism 3140 contained therein to engage an AV (not shown) as needed. Engagement mechanism 3140 includes a charging and/or data transfer port.

The AV can leave the docking station after fully charged or can instruct the charging controller to discontinue charging and then leave the docking station. If the AV batteries become fully charged before the AV disconnects from and/or departs from the docking station the charging controller will discontinue charging. When the AV begins to leave the docking station, the spool urges rocker 3119 to pivot into an undocked position that causes the connector to withdraw back into the docking station.

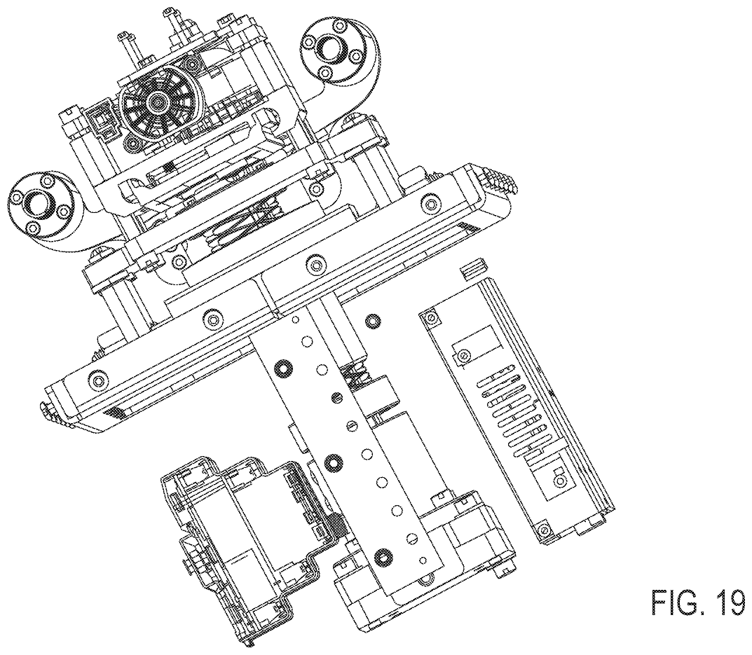

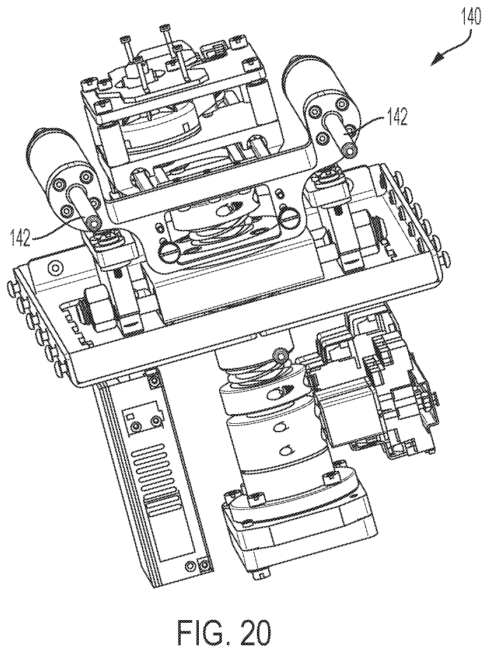

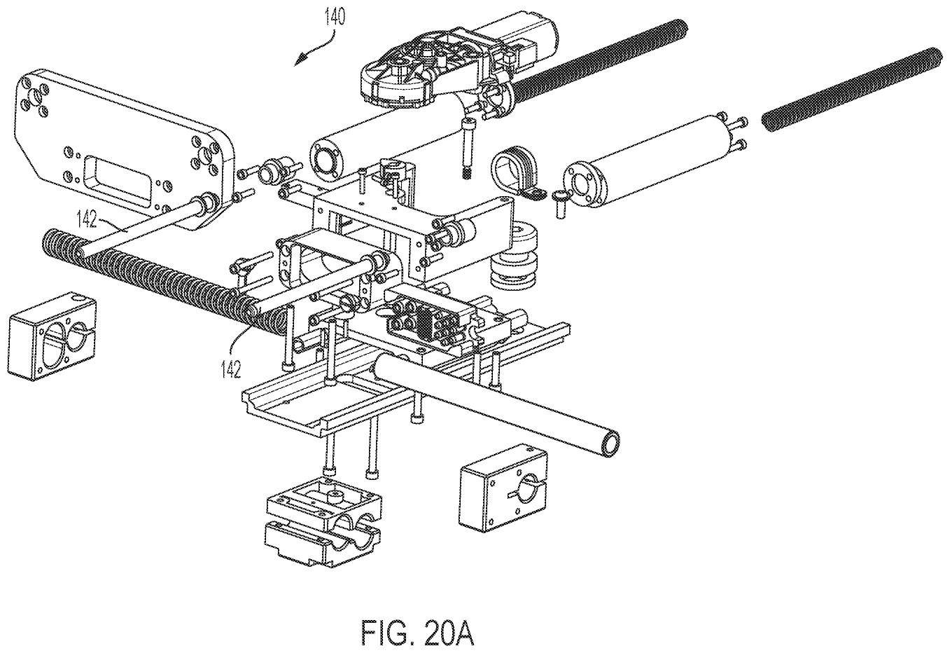

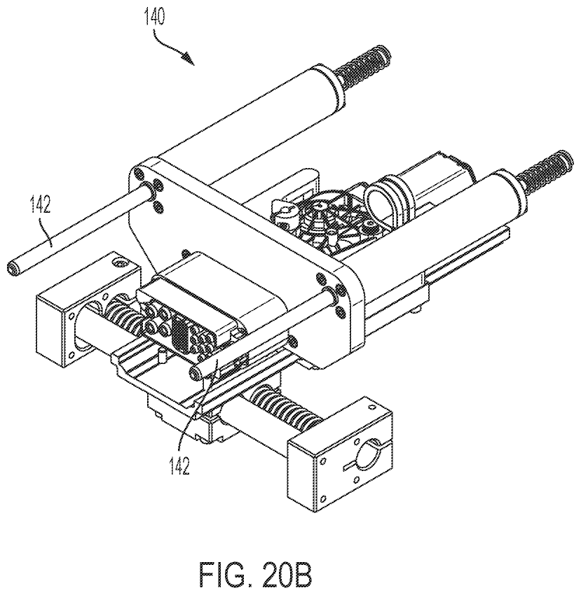

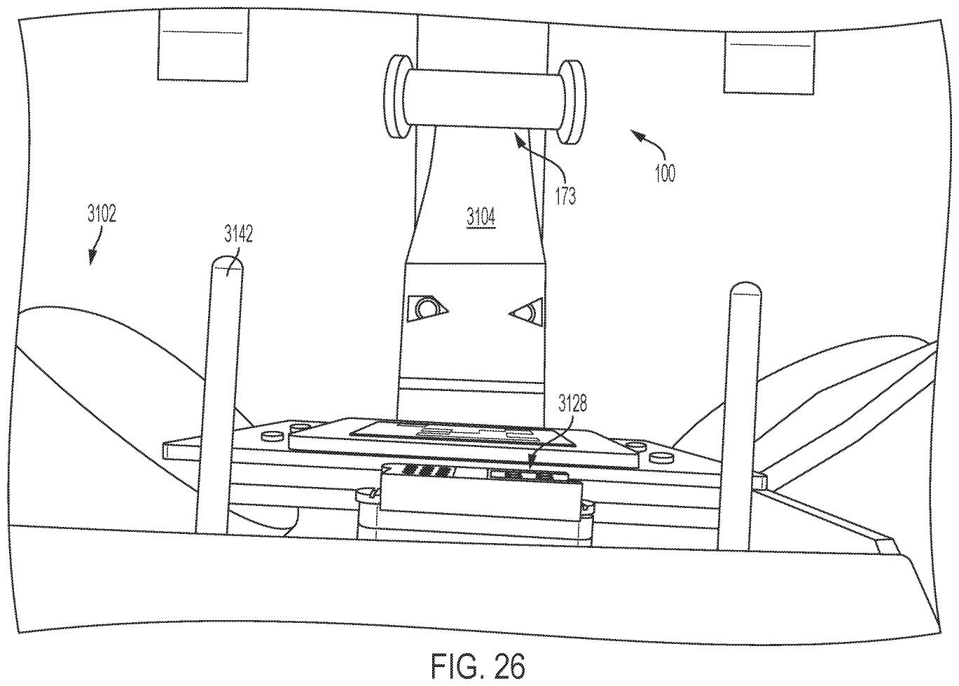

In the perspective views of FIGS. 18, 19, and 20, the partial perspective view of FIG. 20A, and the exploded view of FIG. 20B, an engagement mechanism 3140 is depicted. In the examples shown, the engagement mechanism 3140 is spring loaded and includes two parallel rods 3142 with which to engage an AV (not shown) as needed. This embodiment also employs a switch 3143 that, when contacted by a spool 173 of the AV 100, as shown in FIG. 26, initiates engagement of the AV and docking station connectors and AV battery charging.

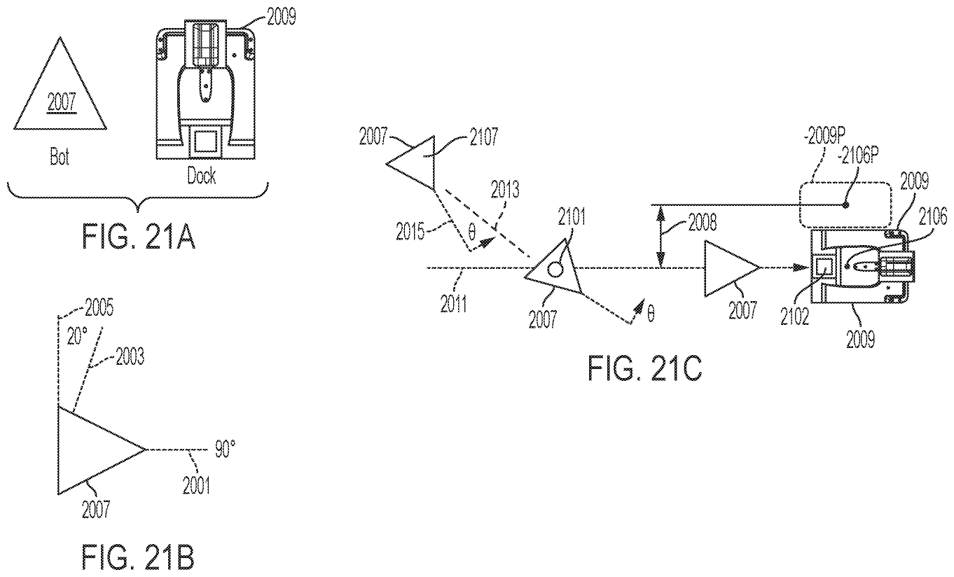

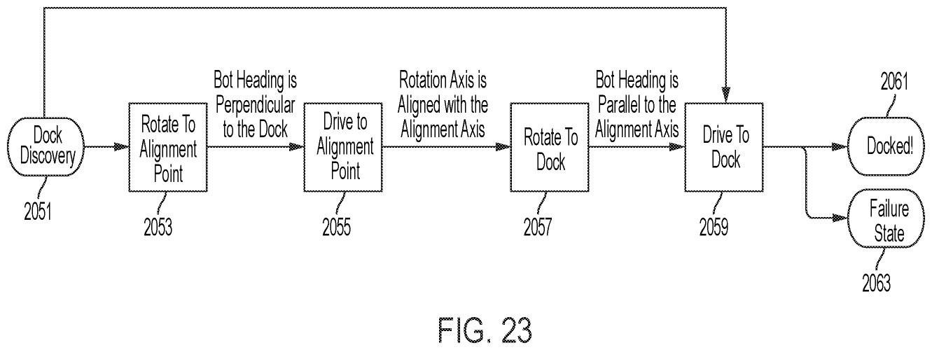

Referring to FIGS. 21C and 23, an example process for docking an AV 2007 is depicted. Preferably, as part of an AV's route, the AV 2007 is provided with an approximate location of an assigned docking station, referred to as a “common docking point” (CDP) 2107. For example, a controlling process external to an AV 2007 may provide a delivery route to the AV 2007 on which the CDP 2107 exists. The CPD, an approximate location of the assigned docking station, is provided because the exact location of the docking station may change over time due to maintenance or other events that cause the docking station to shift location. When AV nears CDP 2107 it begins to query a docking or base station manager for identification and true location of the assigned docking station and its associated docking point (DP) 2106, which is the center of docking station 2009. Responsive to the AV inquiry, the station manager responds with the DP of the assigned docking station or informs the AV that no docking station has been assigned. Where a docking station has been assigned and the AV has been informed of such, the AV will respond with a success or failure message as to whether it was able to apply the docking station information.

Based on the location of DP 2106, an autonomous system of AV 100 generates and appends to the route an alignment or specific docking point (SDP) 2101. SDP 2101 is an approach point that is intended to be aligned with the assigned docking station 2009. At CDP 2107, once properly oriented, control passes to the MPC for navigating the AV 2007 to SDP 2101. At SDP 2101, control passes to a cascade controller that executes an open or closed loop process based on suppled data.

Once arrived at SDP 2101, control passes to a docking controller wherein a cascade controller executes an open loop process based on information received from sensors respecting a perceived location of the physical docking station. AV 2007 is rotated and aligned with alignment axis 2011. AV 2007 then is navigated toward docking station 2009.

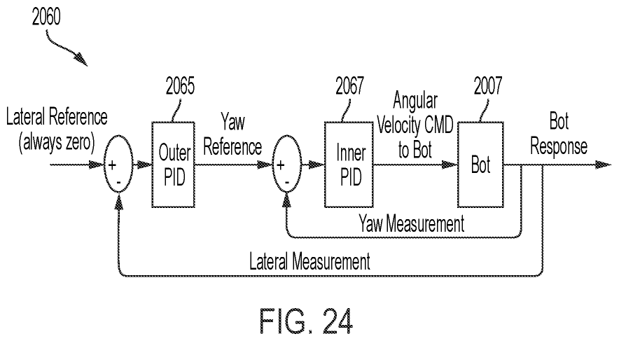

As the docking process begins, as AV 2007 travels from CDP 2107 to SDP 2101 along a path 2013, preferably a Model Predictive Controller (MPC) (not shown) has control. Once arrived at SDP 2101, AV 2007 is spun toward DP 2106 with on-board navigation technology, as shown in and described with reference to FIG. 24 below. Thereafter, velocity and/or yaw of the AV 2007 may be adjusted based on the perceived location of the docking station 2009p, having a docking point 2106p, relative to AV 2007.

Once arrived at SDP 2101, preferably a cascade controller (not shown, described below with reference to FIG. 24) in AV 2007 is given control. Control is open looped as it relies entirely on an initial loading state as opposed to live feedback. Alignment axis 2011 extending from DP 2106 is a reference for measuring a lateral error, a difference 2008 between a Y-position of the perceived DP 2106p relative to the alignment axis 2011. While not typically large, some amount of difference 2008 is expected because physical systems do not behave exactly as modeled; wheels may slip or exhibit wear that renders actual distances traveled different from modeled, predicted values.in some examples lateral error is minimized as velocity is adjusted as an AV 2007 is approaching a docking station 2009.

A sensor (not shown) on the AV 2007 may sense the environment around the AV 2007 over 180° spanning a heading of the AV 2007. A change in direction of an AV 2007 may cause a docking station 2009 to be out of view of sensors (not shown) of the AV 2007. SDP 2101 may incorporate an offset from fiducial markers 2102 on a docking station 2009 respecting a perception range for sensors (not shown) on an AV 2007. In an example, three meters may be a maximum perception range, while 2.5 meters may be a consistently achievable range.

A model predictive controller (MPC) (not shown) of the AV 2007 controls AV 2007 as it navigates toward SDP 2101. AV 2007 may be oriented, for example, from a first path 2015 to a second path 2013, to land at SDP 2101. Once at SDP 2101, AV 2007 is rotated and aligned with DP 2106. Control then passes from the MPC to the docking controller which executes a closed loop process based on data received from sensors trained to locate the actual docking station. Both MPC and docking controller may be executed by the same processor.

In an example, if a transition from the MPC to a docking controller (not shown) of the AV 2007 happens within about 0.8 meters of the alignment axis 2011, the AV 2007 may continue to move along a path 2013 according to directions from the AV's cascade controller (not shown) of the AV 2007. If the transition from the MPC to the docking controller occurs without about 0.8 meters of the alignment axis 2011, the AV 2007 may rotate so that the AV 2007 is generally orthogonal to the alignment axis 2011, drive to within 3 inches laterally of alignment axis 2011, turn toward the docking station 2009, and return control to the cascade controller (not shown). This is because The cascade controller is, preferably, tuned to prioritize lateral error over yaw error. The fastest way to minimize lateral error is to move orthogonally to the alignment axis. As the AV 2007 gets closer to the docking station, pose estimate accuracy improves but maneuverability, i.e. ability to take corrective action, decreases due to a variety of conditions, not limited to railings, potential for collisions with other AVs, limitations of steering to correct errors when near the docking station.

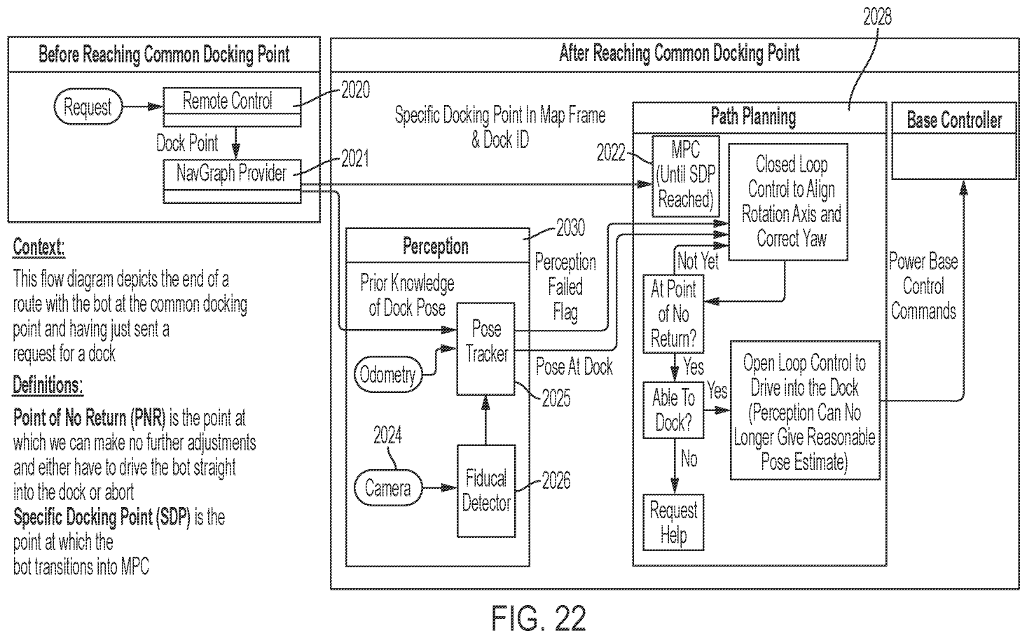

In the flow diagram of FIG. 22, flows of various parts of an example autonomous system for docking an AV with a docking station are depicted. In an example, a remote control operator or remote control software or a combination thereof 2020 determines the docking station (not shown) with which an AV (not shown) should dock. A perception module, e.g., software or firmware instructions executed by a controller, processor, or state machine of the AV, continually transmits pose and correction data for the AV with respect to a target docking station. An MPC 2022 of the AV may be configured to navigate the AV from a CDP within a predetermined range of a docking station to a SDP where the AV is aligned for further navigation to a transition point where the AV is turned toward the docking station and navigated to a DP representing the center of the docking station. In an example, fiducials may be used to indicate the front of the docking station, and sensors, such as a camera 2024 associated with the AV, may sense specific fiducials and provide associated data to a fiducial detector 2026 of the AV. At SDP 2101, the MPC passes control of the AV to a docking controller 2028, which then navigates the AV to the docking station where the AV will dock and engage with a charging and/or data transfer port of the docking station.

Referring to FIG. 22, the Perception Module 2030 executes procedures for detecting with a fiducial detector 2026 ArUco markers in images generated by the short range camera 2024. Once detected, the pose tracker 2025 generates a pose of the AV (not shown) in a frame representing the docking station, defining a pose of the AV relative to the DP associated with the docking station.

The tracker module 2025 receives an initial pose of the AV (not shown) relative to a docking station (not shown). When the AV reaches the CDP 2107, the AV requests a location of the docking station or docking point (DP) 2106 from a docking station network server (DSNS)(not shown) via cellular and/or WAN communications. The DSNS responds by transmitting the DP 2106 and NavGraph Provider 2021 computes a SDP 2101 relative to DP offset by a specified magnitude and orientation.

The tracker module 2025 then receives odometry data from wheel encoders on the AV as well as the pose data for the docking station from the fiducial detect module 2026. The fiducial detect module 2026 parses raw camera images from the camera module 2024 that is in communication with a short range camera. When the fiducial detector module 2026 identifies an ArUco marker, the fiducial detector module 2026 generates a pose in the camera frame, comparable to a plan view, of each ArUco marker. The tracker module 2025 then synthesizes all of the data points and generates a transformed pose of the AV relative to a docking frame where x=0, y=0 and yaw=0 is centered on the docking station. The tracker module 2025 also provides a confidence value respecting the accuracy of the transformed pose and a perception failure flag when the confidence value is outside of an acceptable tolerance.

Referring to FIG. 22, the Path Planning module employs pose data provided by the perception module 2030 to generate and issue motion commands to maneuver the AV onto the docking station. Once the MPC maneuvers the AV to the SDP 2101, the Path Planning module enters a closed loop control routine based on the pose in the dock frame to maneuver the AV towards the docking station. As the AV nears completion of the docking attempt, it will reach a point where the short range camera clearance height is too high to visualize the ArUco markers, at which point open loop control begins. When this transition happens, the docking controller will determine from the pose estimate whether the AV is safe to complete the docking attempt or report a docking failure.

Referring to FIGS. 26 and 31A, a plan view of docking station 3102 shows rods 3142 in repose, awaiting an approaching AV 100. A spool 173 of AV 100 engages a tapered spool guide 3104 extending from docking station 3102 and then guides spool 173 of AV so as to physically position AV 100 laterally relative to the docking station 3102.

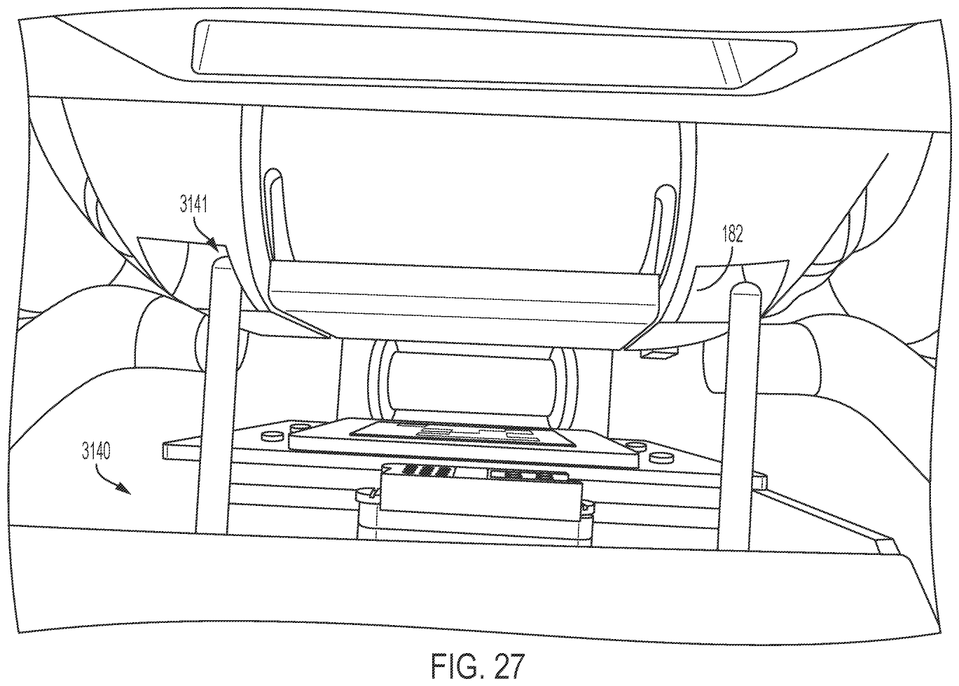

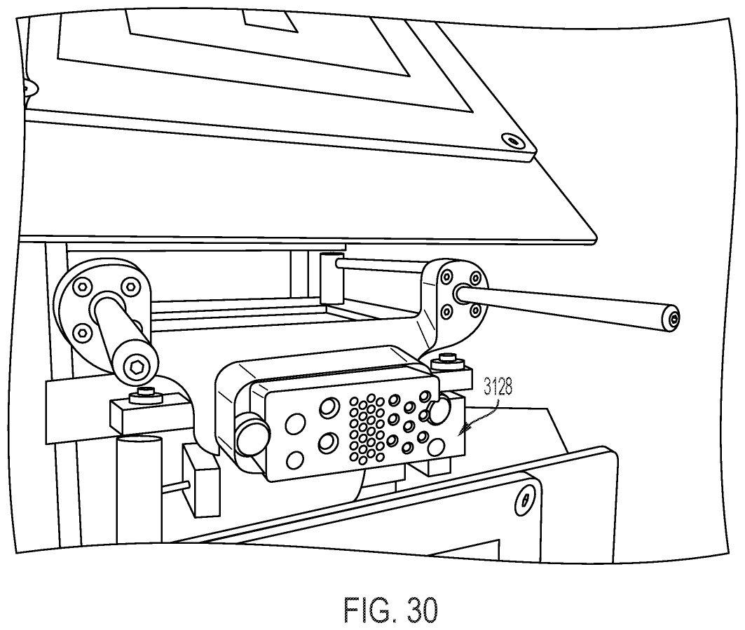

Referring also to FIG. 27, when AV 100 is fully seated in docking station 3102 and engagement mechanism 3140 is initiated for engaging connector 180 of AV 100, as shown in FIG. 31B, with connector 3128 of docking station 3102, as shown in FIGS. 26 and 30. While extending from docking station 3102, distal ends 3141 of rods 3142 eventually contact tapered frusto-conically-shaped recesses 182 of AV 100. As shown in FIG. 27, the side wall taper of recesses 182 aids in positioning rods 3142, hence engagement mechanism 3140, relative to connector 180 to encourage registry and engagement thereof with connector 3128.

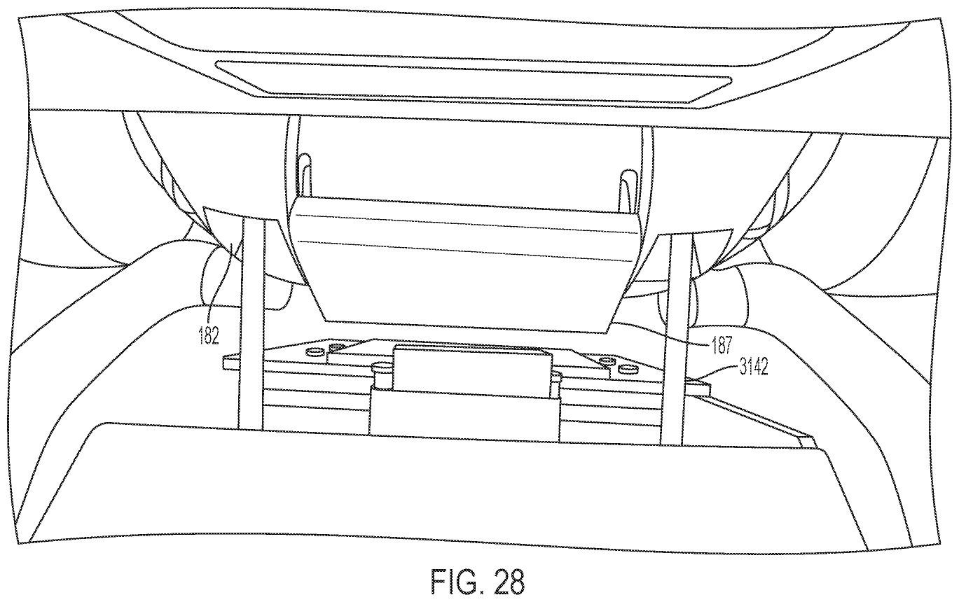

Referring to FIGS. 28 and 31C, distal ends (not shown) of rods 3142, having been fully received in recesses 182, contact and urge inwardly a door latch 183 (shown in FIG. 31A). As door latch 183 is displaced, it urges armatures 185 and 186 to open a door 187, as shown in FIG. 31C. Once fully opened, door 187 exposes connector 180 (shown in FIG. 31B).

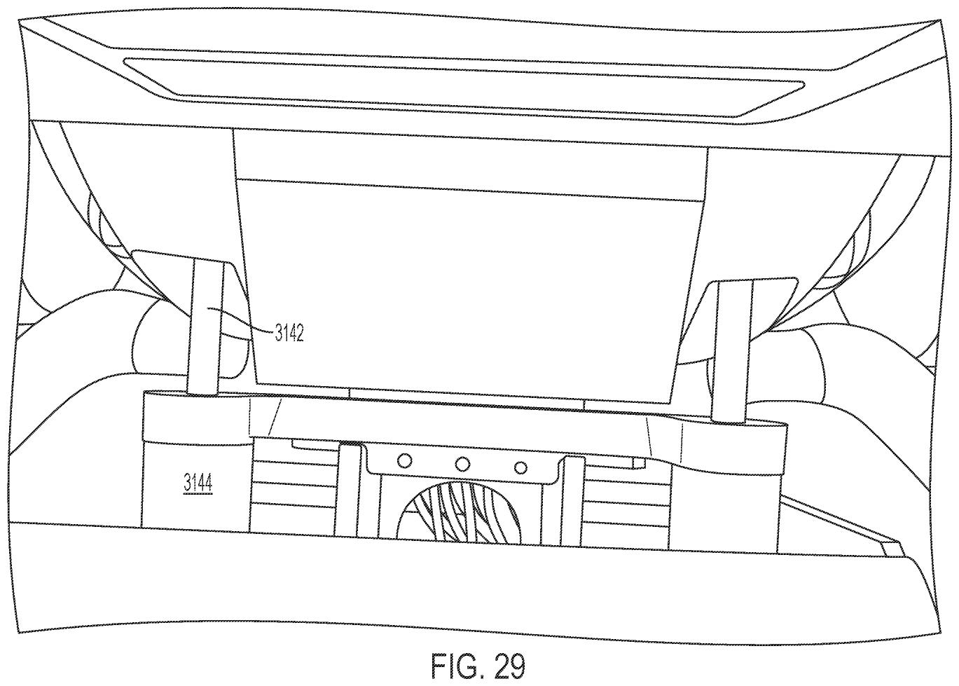

Referring to FIG. 29, after door 187 is fully opened, engagement mechanism 3140 urges connector 3128 to engage with connector 180. Once engaged, charging may commence.

Referring to FIGS. 29 and 34, an embodiment of the invention is configured to avoid damage during engagement of connectors 3128 and 180. Preferably, after rods 3142 has urged door 187 into a fully open position, if engagement mechanism 3140 were to require additional travel to completely seat connectors 3128 and 180, then rods 3142 would have to travel a corresponding amount that would be prevented or cause door latch 183 to distort or break depending on the travel needed and door latch malleability. To avoid incomplete connector seating and/or door latch breakage, rods 3142 are housed and biased against a spring 3145 in a cylinder 3144 that is fixed relative to engagement mechanism 3140. Spring 3145 is configured to have a spring force that is less than a bending force that would cause door latch damage. In operation, as engagement mechanism 3140, hence cylinder 3144, is advanced toward AV and rods 3142 engage and then open door 187, additional travel by engagement mechanism 3140 would cause rods 3142 to travel in cylinder 3144 and compress spring 3145 a corresponding amount.

Following is an example sequence for an AV at rest. First, the AV is started, remaining in low power mode until further instruction. When AV receives a “wake up” command from a controller of a docking station to which the AV is docked, the AV exits low power mode. Based on a route that the docking station controller should have supplied with the “wake up command, the docking controller initiates undocking from the docking station. After undocking, the AV cascade controller executes an open loop process that rotates the AV to an appropriate orientation for undertaking the supplied route using a spin controller. Once rotated, the MPC assumes control for undertaking the route. After completing the route, process flow for docking an AV to a docking station may proceed by a controller, processor, or state machine of the AV executing software of firmware instructions to find a rotation axis for the AV with respect to a CDP. AV is navigated to CDP where AV receives a DP of an assigned docking station and generates an SDP for subsequent navigation. Thereafter, the AV rotates to an appropriate orientation for navigating to the SDP using a spin controller. Once oriented, the MPC assumes control and navigates the AV to the SDP. Once at SDP, to the AV rotates with respect to the assigned docking station by using a spin controller of the AV. Once oriented, the cascade controller executes a closed loop process that navigates the AV to the based on sensor input DP. The assigned docking station may be tracked with respect to a rotation axis of the AV. The AV may continually output pose data based on sensor data the AV obtains. Upon reaching the docking station, the AV commences docking. Once docked, the AV assumes low power mode and commences charging.

In the state diagram of FIG. 23, example states for docking an AV (not shown) are depicted. In an example, a controller in an AV may execute instructions that moves the AV to complete a docking process and drive the AV onto a docking station (not shown). The controller may manage undocking, in an example, driving the AV a pre-selected distance backward and starting navigation from that point. The controller may include, in some examples, a state machine that ascertains a dock discovery state 2051, which is a state in which an AV initiates a docking process. In the discovery state 2051, an AV may attempt to determine it's starting pose relative to a docking station. The AV may use readings from a sensor to determine a confidence level of the pose estimate generated. If the AV's computed confidence level is below a pre-selected tolerance, the AV may enter an open loop cascade controller using an initial pose. An AV may attempt to move within detection range of a sensor until the computed confidence level is within the pre-selected tolerance. The cascade controller may incorporate lateral and yaw error, in some examples, based on fiducials to guide the AV to a docking station in a final stage of the state machine. An initial pose may be a rough estimate until the docking station can be viewed by the AV with a relatively high confidence level. Once the AV confidently detects the docking state (i.e the confidence level . . . ), then the AV will then transition to another state. If the AV sensors do not confidently detect the docking station after a pre-selected timeout, then the AV will then transition to a fault state, possibly coming to a stop. If a docking station is confidently sensed, the AV may transition from the discovery state 2051 to either a Rotate To Alignment Point state 2053 or to a Drive To Alignment Point state 2055, based on an orientation of the AV relative to the docking station. In an example, if a lateral error is large enough relative to the distance (e.g., if the ratio of the lateral error to the distance meets or exceeds a predefined threshold value), the AV transitions to the Rotate To Alignment Point state 2053. If the lateral error is relatively small as compared with the distance (e.g., if the ratio of the lateral error to the distance meets or falls below a predefined floor value), the AV transitions to the Drive To Target state 2059. In the Rotate To Alignment state 2053, the AV rotates away from the DP to a pre-selected angle in the docking frame. When the AV reaches the pre-selected angle it transitions to Drive To Alignment Point state 2055. In the Drive To Alignment Point state 2055, the AV drives forward on a heading until a rotation axis of the AV coincides with an alignment axis for the AV to dock with the docking station. When the rotation axis and the alignment axis coincide, the AV transitions to a Rotate To Dock state 2057. In the Rotate To Dock state 2057, the AV rotates toward the docking station until a heading of the AV is aligned with the alignment axis. The AV then transitions to a Drive To Target state 2059. In the Drive To Target state 2059, the AV performs a closed loop cascade controller pattern to maneuver the bot to the DP. The AV stops after the AV enters either a Docked state 2061, in which the AV has docked successfully with the docking station, or a Failure state 2063, in which the AV has not successfully docked with the docking station.

In the block diagram of FIG. 24, a cascade controller 2060 of an AV 2007 is depicted. The cascade controller 2060 may be implemented in hardware, for example but not limited to as a controller, processor, or state machine coupled to memory storing executable instructions, or as a software of firmware module. In the example shown, a lateral reference may be defined to be a target lateral position of an AV 2007 with respect to an alignment axis of the AV 2007 with respect to a docking station (not shown). A zero lateral reference indicates that the AV 2007 is aligned with the alignment axis. In an example, the cascade controller 2060 includes two PID controllers, an outer PID controller 2065 and an inner PID controller 2067. The cascade controller 2060 may use a command from the outer PID controller 2065 to set a reference for the inner PID controller 2067 that biases the AV 2007 to prioritize correcting the lateral error. In an example, the AV 2007 may iterate executing the cascade controller 2060 until docking is successful or until docking fails. In an example, successful docking may be defined to be a state in which a communications and/or charging bridge between the AV 2007 and the docking station has been established. In an example, failed docking may be defined to be a state in which there is a mechanical/electrical bridge between the AV 2007 and the docking station, but no communications and/or charging signal has been established, indicating that the AV 2007 is physically connected but is not being charged. Iteratively executing the cascade controller 2060 may include feeding back a lateral measurement signal to the zero lateral reference for use as a correction prior to supplying a signal to the outer PID controller 2065. The outer PID 2065 may generate a yaw reference signal. Iterative execution of the cascade controller 2060 may also include feeding back a yaw measurement signal to the yaw reference signal for use as a correction prior to supplying a signal to the inner PID controller 2067. The inner PID controller 2067 may generate a command for the AV 2007 to specify an angular velocity of the AV 2007 relative to the AV 2007, to which the AV 2007 may respond.

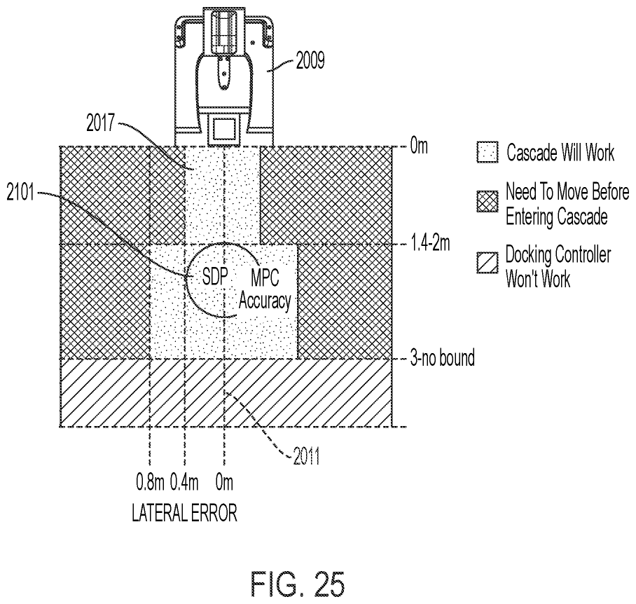

In the diagram of FIG. 25, an example path alignment process is depicted. In the example shown, a SDP 2101 may be defined at a pre-selected distance from an area 2017 in front of a docking station 2009 on an alignment axis 2011 of an AV (not shown). In an example, a controller (not shown) of an AV that may be used for standard navigation passes control to a specific docking controller (also not shown) at a pre-selected distance from the SDP 2101. In an example, the extremes at which an AV can use a cascade controller (not shown) (such as, e.g., the cascade controller 2060 described hereinabove with reference to FIG. 24) of the AV are between (1) a distance between the AV and the SDP 2101 of greater than 2.0 meters longitudinally with a lateral error of less than 0.8 meters and (2) a distance between the AV and the SDP 2101 of less than 2.0 meters longitudinally with a lateral error of less than 0.4 meters, as shown in the area 2017 in front of the docking station 2009. If an AV is positioned outside of these two extremes, the AV will attempt to move to a valid pose, i.e. the AV will operate in a Rotate To Alignment Point state, a Drive To Alignment Point state, and a Rotate To Dock state (as described hereinabove with reference to FIG. 23) until the AV reaches angles of approximately 0° lateral and yaw, at which time the cascade controller of the AV may can take control of the AV. In an example, the lateral error may be a limitation on ideal operating bounds of the cascade controller. In an example, a perception range of an AV may be limited to about 3 meters longitudinally. In an example, a docking station pose estimate may be provided by the pose tracker module 2025 (FIG. 22) that is then targeted by the AV. In an example, an AV may follow a yaw/lateral-corrected path such as, e.g., the path 2013 described hereinabove with reference to FIG. 21 as a cascade controller of the AV provides commands to bring the AV to a docking station 2009. The closer an AV is to a docking station 2009, the more aggressive the yaw and lateral corrections become. In an example, fiducial tags may be detected on a docking station 2009 by an AV, and an estimate of the docking station pose may be continually computed based thereon. Using the pose estimate, an AV may stop if a confidence level in the pose estimate becomes too low or if the AV cannot safely dock. In some examples such a check may not need to be performed when the AV approaches the docking station 2009 rocker if the lateral and yaw errors are inside a pre-selected tolerance window, which can be achieved when the AV is about to dock and is correctly aligned with the docking station 2009. At that point, such fiducial tags may be out of the sight or sensor capability of the AV due to its proximity to them. In an example, an AV may determine that it is not safe to dock if its emergency brake is active.

The AV may rely on a threshold confidence level in the data it receives from sensors associated with the AV. Whether the emergency brake is active or the confidence estimate is too low, the AV may stop moving but may decline to enter a fault condition until the event has persisted for a pre-selected duration of time. If the event clears before the pre-selected duration of time has expired, the AV may continue docking with the docking station 2009. If the event does not clear before the pre-selected duration of time has expired, a docking failure alert may be raised and the AV may enter a fault state. In an example, fiducial tags may include Aruco markers that may be detected by conventional methods. To detect a marker on a docking station, an AV may receive, for example but not limited to, an RGB image. The AV may contain a dictionary of associated markers for its assigned docking station. After detecting all assigned markers in the camera image, the AV may converge the markers and output a single transform denoting the location of the dock.

In some examples, when AVs are docked in docking stations to charge, thermal control of the charging area might be necessary. To be charged, the AVs may be parked outside a distribution center, for example. A charging station may be built into a wall of the distribution center. Example charging stations may include a device that pumps air from inside the thermally controlled distribution center onto the AV and/or docking station. Such air flow may mitigate concerns about extreme temperatures for the AV and other charging elements. The pumping device may be configured to operate only while charging occurs. In some examples a footprint of an access channel between an inside and an outside of a distribution center may be relatively small to mitigate security concerns for the AVs.

In an example, with respect to charging one or more batteries of an AV, a charging station may be configured to charge an AV from empty to 80% full in one hour or less, and from empty to 100% full in 1.5 hours or less (referred to collectively as the 1C rate). In a non-limiting example, it is possible to optionally add enough storage capacity to charge up to two AVs at the 1C rate while they are connected to a 110 Volt/15 Amp circuit. A system as described herein may require no human user intervention to enable charging of AVs, and the AV charging cycle may begin whether the AV is powered on or powered off.

Another embodiment of the invention includes “shore power” mode for ensuring that the autonomy system of the AV remains energized. After an AV is docked and/or charging, the driver system is powered down while the autonomy system remains operational. To do so, the autonomy system draws power from a second power supply in the docking system, which may be supplied from a local power grid. In this manner, the autonomy system remains “alive” but does not run on the batteries.

An embodiment of the invention relies on a multiplexer or MUX board that is energized when the AV is docked and the AV and docking station connectors are engaged. Connector engagement completes a circuit and permits current flow across connector pins (not shown) that energizes the MUX board. The MUX board includes logic circuits and sensors that are responsive to a voltage level of the battery and any auxiliary power from the docking station. The MUX board automatically switches the power source for the autonomous system from the power source exhibiting a lower voltage, such as when the driver system, hence the battery, is shut down for charging, to the auxiliary or shore power supply.

With respect to camera calibration, in an example, a system as described herein may include a camera calibration target for each of one or more cameras associated with an AV. In an example, one camera calibration target may occupy the center fifth of a camera image. In an example, moving and/or stationary camera calibration targets are enabled. In an example, one or more cameras associated with an AV may be automatically calibrated when the AV is parked in or near a docking station.

In an example, various statuses may be indicated, including but not limited to battery charge level, battery charging status, camera calibration status, data transfer status, errors associated with an AV, and/or errors associated with a docking station, if any. Primary and secondary status indication media may be supported in some examples. For example, a status may be displayed on a screen associated with an AV, or a status may be indicated by light patterns and/or audio beeps and/or haptic feedback, in particular but not limited to when the AV is powered off. In an example, a system as described herein may include an electrical connection of 120 Volts-240 Volts, single phase or 3-phase, 50 Hz or 60 Hz. A power supply may reside in a docking station in some examples, with a blower fan under a baffle to draw air over fins. A fan may be used in some examples, which may be long and thin and aim to provide consistent air flow. In an example docking stations and/or base stations may include cargo containers. In an example two pins may be shorted together on a back of a docking station to enhance capability to identify the docking station. When pins that are shorted on the AV make contact with powered pins on docking station, the circuit is completed and full connector engagement can be assured.

In some examples certain terms may be defined as follows. The DP may be defined as a global point at which a docking station is located, and which should be just above a current fiducial tag. An alignment axis may be defined as an axis that extends outward from a docking pose estimate that is used to guide an AV to the docking station. A rotation axis may be defined to be a point about which an AV rotates, for example a midpoint between two rear wheels of the AV. A heading may be defined to be a direction in which an AV is facing. A lateral error may be defined to be a shortest distance between a rotation axis and an alignment axis. An azimuth, or yaw, error may be defined to be an angle between a heading of an AV and an alignment axis. An alignment point may be defined to be a point selected on an alignment axis that an AV targets to minimize lateral error. A docking pose estimate may be defined to be a pose of an AV that maximizes the chances of the AV successfully docking. A docking pose estimate may include a point and a heading. The CDP may be defined as a last point in a route file of an AV. The CDP may denote a start area where docking takes place without specifying a location of any given docking station. The SDP may be defined as a point that designates where an actual docking station is located. A specific docking point may be provided to an AV after the AV has begun traveling. An AV may travel from a CDP to a specific docking point. A fiducial tag, which may be an Aruco marker, may be a marker such as, for example but not limited to, a QR code on a docking station. An AV may use one or more fiducial tags during docking to estimate a position of the AV. A docking controller may be defined as a controller in an AV that is active after the AV reached the SDP. A docking controller may complete a docking process, driving an AV onto a physical docking station. An undocking controller may be defined as a controller in an AV that is active when the AV starts to undock from and leave a docking station. An undocking controller may drive an AV backward a distance from the docking station. In some examples the distance may be three meters. The distance may be such that the AV is near a first point in its route (as may be obtained from a route file of the AV). After undocking, an AV may transition to an MPC controller in the AV and being traveling on a route.

In some examples a cascade controller of an AV may prioritize lateral error over azimuth error initially, and may gradually weight azimuth error more heavily related to lateral error as distance between an AV and a docking station decreases. In some examples velocity of an AV may increase or decrease as distance between the AV and a docking station decreases. When the lateral distance is large, the commanded turn rate may be high and linear velocity low. As the lateral error decreases, the commanded turn rate may decrease and linear velocity increase. An AV may be placed in an orientation in which a target docking station is visible to the AV (i.e., the target docking station is detectable by sensors of the AV), and an AV may in an example have a 180-degree field of view.

In some examples a method of docking an AV to a docking station includes driving the AV to an aligning point (which may include continually updating the alignment point during driving, or which may include reevaluating the alignment upon arrival at the alignment point), arriving at an alignment point, rotating toward a docking point, and driving toward a docking station. In the action of driving toward a docking station, the AV may adjust yaw as needed. The AV may maintain a heading that is aligned or substantially aligned with an alignment axis. The AV may minimize lateral error.

In some examples an AV may follow a trajectory to a docking station pose. A docking pose may be estimated, and a trajectory may then be generated and then followed, and may optionally be updated periodically or continually as the docking pose is re-estimated and the estimate improves. When the docking station pose is reached, the AV may drive straight on its heading, making minimal adjustments. When perception is lost, i.e., when the AV is close enough to the docking station to no longer be able to read fiducial tags on the docking station due to their respective angles with respect to one or more cameras or sensors on the AV, the AV may drive straight on its heading.

In non-limiting examples, a system for docking an AV is provided, the system comprising one or more processors and one or more memories that stores executable instructions that, when executed by the one or more processors, can facilitate performance of the operations as described herein, including the non-limiting methods as illustrated in the various flow diagrams of the drawings.

Information and signals may be represented using any of a variety of different techniques. For example, data, instructions, commands, information, signals, bits, or symbols that may be referenced throughout the description may be represented by voltages, currents, electromagnetic waves, magnetic fields or particles, optical fields or particles, ultrasonic waves, projected capacitance, or any combination thereof.

The various illustrative logical blocks, modules, circuits, and algorithm steps described in connection with the arrangements disclosed herein may be implemented as electronic hardware, computer software, or combinations of both. To clearly illustrate this interchangeability of hardware and software, various illustrative components, blocks, modules, circuits, and steps have been described in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the appended claims.

The various illustrative logical blocks, modules, and circuits described in connection with the arrangements disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The actions of a method or algorithm described in connection with the arrangements disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other known form of storage medium. A storage medium may be coupled to the processor such that the processor can read information from, and write information to, the storage medium. In the alternative, the storage medium may be integral to the processor. The processor and the storage medium may reside in an ASIC. The ASIC may reside in functional equipment such as, e.g., a computer, a robot, a user terminal, a mobile telephone or tablet, a car, or an IP camera. In the alternative, the processor and the storage medium may reside as discrete components in such functional equipment. Additionally or in the alternative, at least one of the processor and/or the storage medium may reside in a cloud-based network such as, e.g., the Internet.

The above description is not intended to be exhaustive or to limit the features to the precise forms disclosed. Various alternatives and modifications can be devised without departing from the disclosure, and the generic principles defined herein may be applied to other arrangements without departing from the spirit or scope of the appended claims. Accordingly, the present disclosure is intended to embrace all such alternatives, modifications, and variations. Additionally, while several examples of the present disclosure have been shown in the drawings and/or discussed herein, it is not intended that the disclosure be limited thereto, as it is intended that the disclosure be as broad in scope as the art will allow and that the specification be read likewise. Therefore, the above description should not be construed as limiting, but merely as examples of particular configurations. And it should be envisioned that other modifications may be made within the scope and spirit of the claims appended hereto. Other elements, steps, actions, methods, and techniques that are not substantially different from those described above and/or in any appended claims are also intended to be within the scope of the disclosure. Thus, the appended claims are not intended to be limited to the examples shown and described herein, but are to be accorded the broadest scope consistent with the principles and novel features disclosed herein.

Configurations of the present teachings are directed to computer systems for accomplishing the methods discussed in the description herein, and to computer readable media containing programs for accomplishing these methods. The raw data and results can be stored for future retrieval and processing, printed, displayed, transferred to another computer, and/or transferred elsewhere. Communications links can be wired or wireless, for example, using cellular communication systems, military communications systems, and satellite communications systems. Parts of the system can operate on a computer having a variable number of CPUs. Other alternative computer platforms can be used.

The present configuration is also directed to software/firmware/hardware for accomplishing the methods discussed herein, and computer readable media storing software for accomplishing these methods. The various modules described herein can be accomplished on the same CPU, or can be accomplished on different CPUs. In compliance with the statute, the present configuration has been described in language more or less specific as to structural and methodical features. It is to be understood, however, that the present configuration is not limited to the specific features shown and described, since the means herein disclosed comprise preferred forms of putting the present configuration into effect.

Methods can be, in whole or in part, implemented electronically. Signals representing actions taken by elements of the system and other disclosed configurations can travel over at least one live communications network. Control and data information can be electronically executed and stored on at least one computer-readable medium. The system can be implemented to execute on at least one computer node in at least one live communications network. Common forms of at least one computer-readable medium can include, for example, but not be limited to, a floppy disk, a flexible disk, a hard disk, magnetic tape, or any other magnetic medium, a compact disk read only memory or any other optical medium, punched cards, paper tape, or any other physical medium with patterns of holes, a random access memory, a programmable read only memory, and erasable programmable read only memory (EPROM), a Flash EPROM, or any other memory chip or cartridge, or any other medium from which a computer can read. Further, the at least one computer readable medium can contain graphs in any form, subject to appropriate licenses where necessary, including, but not limited to, Graphic Interchange Format (GIF), Joint Photographic Experts Group (JPEG), Portable Network Graphics (PNG), Scalable Vector Graphics (SVG), and Tagged Image File Format (TIFF).

While the present teachings have been described above in terms of specific configurations, it is to be understood that they are not limited to these disclosed configurations. Many modifications and other configurations will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

A docking system, comprising: a connector coupled to an electronics housing of a docking station and configured to operably engage an AV to couple the AV to the electronics housing; a processor coupled to the connector and configured to enable fast-charging of the AV through the connector; a processor coupled to the connector and configured to transfer data to and receive data from the AV through the connector; and a processor of the AV configured to automatically align the AV with the connector.

The docking system of the previous clause, further comprising a weather enclosure coupled to the docking station.

We claim:

1. Docking system comprising:
a sensor configured to respond to a presence of a vehicle;
a dock processor configured to be responsive to said sensor;
a dock connector; and
an engagement mechanism configured to be responsive to said dock processor for aligning and operatively connecting said dock connector and a vehicle connector and defining a connection.

2. Docking system of claim 1 wherein said sensor is selected from: an electronic switch; a rocker; and combinations thereof.

3. Docking system of claim 1 wherein the connection enables and/or triggers: charging of a battery of the vehicle; communications with the vehicle; data transfer with the vehicle; and combinations thereof.

4. Docking system of claim 3 wherein the communications and/or the data transfer are wireless.

5. Docking system of claim 1 wherein said engagement mechanism is configured urge said dock connector toward the vehicle connector.

6. Docking system of claim 1 further comprising:
a locating pin fixed relative to said dock connector; and
a locating recess fixed relative to the vehicle connector and configured to receive and guide said locating pin during the connecting.

7. Docking system of claim 6 further comprising a door configured to cover the vehicle connector;
wherein said locating recess is configured to allow locating pin to open said door during the connecting.

8. Docking system of claim 1 further comprising a station relative to which said dock connector is mounted, said station being configured to secure a vehicle.

9. Docking system of claim 8 further comprising a guide fixed relative to the station and configured to guide a spool that is fixed relative to the vehicle.

10. Docking system of claim 1 further comprising a housing configured to shield said dock connector from adverse conditions.

11. Docking system of claim 1 wherein said dock processor is configured to confirm operability of the connection.

12. Method of docking a vehicle comprising:
calculating an alignment point based on a docking point;
first navigating to the alignment point;
aligning relative to the docking point;
second navigating toward the docking point along a path; and
arriving at a docking station.

13. Method of claim 12 further comprising, prior to said calculating:
navigating to a common docking point;
requesting a docking point; and
receiving data respecting the docking point.

14. Method of claim 12 further comprising, prior to said arriving:
reckoning a position of the docking station relative to the vehicle; and
if said reckoning reveals a difference between the position and the docking point, then adjusting the path to align with the docking station.

15. Method of claim 14 wherein said reckoning comprises locating a fiducial marker on the docking station.

16. Method of claim 15 wherein said reckoning comprises:
generating a vehicle pose of the vehicle in a camera frame;
generating a fiducial pose of the fiducial marker in the camera frame;
generating a docking frame corresponding to the docking point; and
generating a transformed pose of the vehicle based on the camera frame and the docking frame;
wherein said adjusting is based on the transformed pose.

17. Method of claim 16 further comprising:
generating a confidence value associated with the transformed pose; and, if said reckoning ceases possibility, then
determining from the confidence value whether said second navigating is safe.

18. Method of transferring data with a vehicle and/or charging a battery of a vehicle
according to claim 12 further comprising:
triggering an engagement mechanism comprising a dock connector to initiate aligning and connecting the dock connector and a vehicle connector;
connecting by the vehicle connector with the dock connector and defining a connection; and
receiving data and/or charging via the connection.
